(19) United States
(12) Patent Application Publication
(10) Pub. No.: US 2015/0376477 A1
(43) Pub. Date: Dec. 31, 2015

(54) PRESSURE-SENSITIVE ADHESIVE COMPOSITION, PRESSURE-SENSITIVE ADHESIVE LAYER, PRESSURE-SENSITIVE ADHESIVE SHEET, OPTICAL COMPONENT, AND TOUCH PANEL

(71) Applicant: NITTO DENKO CORPORATION, Ibaraki-shi (JP)

(72) Inventors: Hirofumi Katami, Ibaraki-shi (JP); Takahiro Nonaka, Ibaraki-shi (JP); Hiroaki Kishioka, Ibaraki-shi (JP)

(73) Assignee: NITTO DENKO CORPORATION, Ibaraki-shi (JP)

(21) Appl. No.: 14/767,379

(22) PCT Filed: Jan. 28, 2014
(86) PCT No.: PCT/JP2014/051760

§ 371 Date: Aug. 12, 2015

(30) Foreign Application Priority Data
Feb. 14, 2013 (JP) 2013-026610
Jun. 7, 2013 (JP) 2013-120385

(51) Int. Cl. C09J 133/14; C08K 5/3475; G06F 3/041; C09J 11/06

(52) U.S. Cl. CPC C09J 133/14; C09J 11/06; C08K 5/3475; G06F 3/0412; G06F 3/0414

(57) ABSTRACT

Provided are an optical component having an excellent corrosion inhibition effect while achieving a high level of adhesion reliability and transparency, and pressure-sensitive adhesive composition and sheet that can produce such an optical component efficiently at a low cost. The pressure-sensitive adhesive composition according to the present invention includes a rust inhibitor, and a mixture of at least one monomer component for constituting a base polymer or a partially polymerized product of a mixture of at least one monomer component for constituting a base polymer. The monomer component includes no or substantially no acid group-containing monomer. The pressure-sensitive adhesive composition contains no or substantially no organic solvent. The pressure-sensitive adhesive sheet has a pressure-sensitive adhesive layer formed from such pressure-sensitive adhesive composition.

### TECHNICAL FIELD

The present invention relates to a pressure-sensitive adhesive composition, a pressure-sensitive adhesive layer, a pressure-sensitive adhesive sheet, an optical component, and a touch panel.

### BACKGROUND ART

Display devices, such as a liquid crystal display (LCD), and input devices, such as a touch panel, are being widely used in various fields. When manufacturing such a display device or input device, a pressure-sensitive adhesive sheet is used for bonding an optical component. For example, a transparent pressure-sensitive adhesive sheet is used for bonding an optical component in various display devices, such as a touch panel.

These display devices and input devices suffer from the problem that their metal wiring corrodes due to the entry of moisture, acid gas, salt water, or a corrosive material from the external environment. With the size increase and frame thinning of sensors in recent years, devices or sensors with copper wiring are on the increase accordingly. Copper is known to have the second best electrical conductivity, following silver, and is thus a useful material for wiring. However, copper is also known to be susceptible to oxidation and corrosion. For inhibiting the oxidation and corrosion of metal wiring, it is common to coat a moisture-proof protective layer on the metal wiring so as to prevent the entry of moisture or a corrosive material (Patent Literature 1).

### CITATION LIST

### Patent Literature

Patent Literature 1: Japanese Patent Laid-Open No. 2011-28594

### SUMMARY OF INVENTION

### Technical Problem

However, the above-described coating, which is carried out after forming the metal wiring, requires extra processes and operations to cause a large problem in terms of reducing the production yield and in terms of cost. Further, in some cases, the use of a moisture-proof protective layer causes problems in obtaining transparency and adhesion reliability, such as adhesion and resistance to foaming and release (property in which foaming and release is less likely to occur at the interface between a pressure-sensitive adhesive sheet and an adherend under a high-temperature environment).

Furthermore, since the visibility in a display part is required in a display device or an input device, the pressure-sensitive adhesive sheet used in a display device or an input device is required to have excellent appearance so as not to adversely affect the visibility.

Therefore, it is an object of the present invention to provide an optical component (especially, an optical component with a pressure-sensitive adhesive sheet) that has an excellent corrosion inhibition effect on metal wiring, such as copper wiring, while achieving a high level of transparency and adhesion reliability, such as adhesion and resistance to foaming and release (property in which foaming and release is less likely to occur at the interface between a pressure-sensitive adhesive sheet and an adherend under a high-temperature environment). It is another object of the present invention to provide a pressure-sensitive adhesive layer capable of producing such an optical component efficiently at a low cost, a pressure-sensitive adhesive composition for forming such a pressure-sensitive adhesive layer, and a pressure-sensitive adhesive sheet.

Further, it is another object of the present invention to provide a pressure-sensitive adhesive layer capable of producing an optical component excellent in visibility efficiently at a low cost, a pressure-sensitive adhesive composition for forming such a pressure-sensitive adhesive layer, and a pressure-sensitive adhesive sheet.

### Solution to Problem

After intensive investigations to achieve the objects, the present inventors have found that adhesion reliability, transparency, and a corrosion inhibition effect could be obtained by using a suitable base polymer for forming the pressure-sensitive adhesive layer, and using a rust inhibitor, thereby completing the present invention.

Further, the present inventors have found that a pressure-sensitive adhesive composition with no or substantially no organic solvent is able to form a pressure-sensitive adhesive layer excellent in appearance, and that the visibility is not adversely affected when such a pressure sensitive adhesive layer is used for an optical component and the like, thereby completing the present invention.

Furthermore, the present inventors have found that the use of both a rust inhibitor and a monomer component, for constituting a base polymer, that includes no or substantially no acid group-containing monomer leads to synergetic effect in the corrosion inhibition, thereby completing the present invention.

Specifically, the present invention provides, in one aspect, a pressure-sensitive adhesive composition includes a rust inhibitor, and a mixture of at least one monomer component for constituting a base polymer or a partially polymerized product of a mixture of at least one monomer component for constituting a base polymer. The monomer component includes no or substantially no acid group-containing monomer. The pressure-sensitive adhesive composition contains no or substantially no organic solvent.

The present invention provides, in another aspect, a pressure-sensitive adhesive composition includes a rust inhibitor and a base polymer. The base polymer includes no or substantially no acid group-containing monomer as a constituent monomer component. The pressure-sensitive adhesive composition contains no or substantially no organic solvent.

The present invention provides, in another aspect, a pressure-sensitive adhesive composition includes a rust inhibitor, and a mixture of at least one monomer component for constituting an acrylic polymer (A) or a partially polymerized product of a mixture of at least one monomer component for constituting an acrylic polymer (A). The monomer component includes no or substantially no acid group-containing monomer. The pressure-sensitive adhesive composition contains no or substantially no organic solvent.

The present invention provides, in another aspect, a pressure-sensitive adhesive composition includes a rust inhibitor and an acrylic polymer (A). The acrylic polymer (A) includes no or substantially no acid group-containing monomer as a constituent monomer component. The pressure-sensitive adhesive composition contains no or substantially no organic solvent.

Preferably, a hydroxyl group-containing monomer is not less than 5 parts by weight based on a total amount (100 parts by weight) of the monomer component for constituting the acrylic polymer (A).

Preferably, a nitrogen atom-containing monomer is not less than 5 parts by weight based on a total amount (100 parts by weight) of the monomer component for constituting the acrylic polymer (A).

Preferably, the rust inhibitor is a benzotriazole-based compound.

The present invention provides, in another aspect, a pressure-sensitive adhesive layer formed from the above-described pressure-sensitive adhesive composition.

Preferably, the pressure-sensitive adhesive layer has a haze (based on JIS K7136) of 1.0% or less.

Preferably, the pressure-sensitive adhesive layer has a total light transmittance (based on JIS K7361-1) of 90% or more.

The present invention provides, in another aspect, a pressure-sensitive adhesive sheet includes the above-described pressure-sensitive adhesive layer.

Preferably, the pressure-sensitive adhesive sheet has a 180° peel adhesion strength to a glass plate of 8 N/20 mm or more.

Preferably, the pressure-sensitive adhesive sheet has a thickness of 12 to 350 μm.

The present invention provides, in another aspect, an optical component includes a base material with metal wiring on at least one side thereof, and at least one of the above-described pressure-sensitive adhesive sheets being attached onto the metal wiring side of the base material.

Preferably, the metal wiring in the optical component is copper wiring.

The present invention provides, in another aspect, a touch panel includes a base material with metal wiring on at least one side thereof, and at least one of the above-described pressure-sensitive adhesive sheets being attached onto the metal wiring side of the base material.

Preferably, the metal wiring in the touch panel is copper wiring.

### Advantageous Effects of Invention

Since the pressure-sensitive adhesive composition according to the present invention has adhesion reliability, transparency, and an corrosion inhibition effect, an optical component can be obtained that has an excellent corrosion inhibition effect on metal wiring, such as copper wiring, while achieving a high level of transparency and adhesion reliability, such as adhesion and resistance to foaming and release, as well as a pressure-sensitive adhesive layer and a pressure-sensitive adhesive sheet capable of producing such an optical component can be obtained. Further, the use of the pressure-sensitive adhesive composition with corrosion inhibition ability enables the processes to avoid a protective layer-coating step to reduce the number of processes, which decreases costs and improves yield.

Further, since the pressure-sensitive adhesive composition according to the present invention can prevent the occurrence of orange peel and the like to provide a pressure-sensitive adhesive layer excellent in appearance, an optical component excellent in visibility can be obtained, as well as a pressure-sensitive adhesive layer and a pressure-sensitive adhesive sheet capable of producing such an optical component can be obtained.

### BRIEF DESCRIPTION OF DRAWINGS

FIG. 1 is a series of schematic diagrams illustrating preferred embodiments of an optical component according to the present invention.

FIG. 2 is a series of schematic diagrams illustrating preferred embodiments of a touch panel according to the present invention.

FIG. 3 is a top plan view of a glass with a step used in the evaluation of resistance to foaming and release.

FIG. 4 is a cross-sectional view (cross-sectional view along the line A-A′) of the above glass with a step.

FIG. 5 is a cross-sectional view (cross-sectional view along the line B-B′) of the above glass with a step.

FIG. 6 is a schematic plan view illustrating an example of a metal wiring pattern.

### DESCRIPTION OF EMBODIMENTS

[1. Pressure-Sensitive Adhesive Composition and Pressure-Sensitive Adhesive Layer]

The pressure-sensitive adhesive composition according to the present invention, in one aspect, is not especially limited provided that it contains a rust inhibitor and a base polymer, that the base polymer includes no or substantially no acid group-containing monomer as a constituent monomer component, and that the composition contains no or substantially no organic solvent.

The pressure-sensitive adhesive composition according to the present invention, in another aspect, is not especially limited provided that it contains a rust inhibitor and a mixture of at least one monomer component for constituting a base polymer or a partially polymerized product of a mixture of at least one monomer component for constituting a base polymer, that the monomer component includes no or substantially no acid group-containing monomer, and that the composition contains no or substantially no organic solvent.

In the present specification, the above “mixture of at least one monomer component” includes cases in which the mixture is formed from a single monomer component and cases in which the mixture is formed from two or more monomer components. The above “partially polymerized product of a mixture of at least one monomer component” means a composition obtained by partially polymerizing one monomer component or a plurality of monomer components in the “mixture of at least one monomer component.”

The pressure-sensitive adhesive composition according to the present invention may contain at least a base polymer and a rust inhibitor. Arranging the composition such that the monomer component for constituting the base polymer includes no or substantially no acid group-containing monomer and that the composition contains a rust inhibitor leads to synergetic effect in the corrosion inhibition, thereby achieving an excellent corrosion inhibition.

The pressure-sensitive adhesive composition according to the present invention may be arranged such that the composition contains a rust inhibitor and an acrylic polymer (A), that the acrylic polymer (A) contains no or substantially no carboxyl group-containing monomer as a constituent monomer component, and that the composition contains no or substantially no organic solvent.

The pressure-sensitive adhesive composition according to the present invention may be arranged such that the composition contains a rust inhibitor and a mixture of at least one monomer component for constituting an acrylic polymer (A) or a partially polymerized product of a mixture of at least one monomer component for constituting an acrylic polymer (A), that the monomer component includes no or substantially no acid group-containing monomer, and that the composition contains no or substantially no organic solvent.

The pressure-sensitive adhesive composition according to the present invention can be in any form. Examples include an emulsion type, a hot-melt type, and a solventless type (an active energy ray-curable type, for example, a monomer mixture, or a monomer mixture and a partially polymerized product thereof). Especially, the pressure-sensitive adhesive composition according to the present invention is preferably not a solvent type. This is because a pressure-sensitive adhesive layer made from a solvent type pressure-sensitive adhesive composition tends to occur appearance defects, such as orange peel. Note that “orange peel” means a phenomenon in which unevenness similar to that of the skin of a “yuzu orange” which is a kind of citrus occurs. Further, the pressure-sensitive adhesive composition according to the present invention is preferably an active energy ray-curable type in terms of obtaining a pressure-sensitive adhesive layer excellent in appearance. In the present specification, pressure-sensitive adhesive composition means a composition used for forming a pressure-sensitive adhesive layer, and includes a meaning of a composition used for forming a pressure-sensitive adhesive.

Although the above-described organic solvent is not especially limited as long as it is an organic compound used as a solvent, examples include hydrocarbon-based solvents, such as cyclohexane, hexane, and heptane; aromatic solvents, such as toluene and xylene; ester-based solvents, such as ethyl acetate and methyl acetate; ketone-based solvents, such as acetone and methyl ethyl ketone; and alcohol-based solvents, such as methanol, ethanol, butanol, and isopropyl alcohol. Note that the above-described organic solvent may be a mixed solvent comprising two or more organic solvents.

In the pressure-sensitive adhesive composition according to the present invention, the term “contain substantially no organic solvent” refers to not being artificially added with such an organic solvent, excluding cases in which such an organic solvent is inevitably contained. Specifically, a pressure-sensitive adhesive composition can be said to contain substantially no organic solvent if the content of the organic solvent in the pressure-sensitive adhesive composition is, based on the total amount (total weight, 100 wt. %) of the pressure-sensitive adhesive composition, not more than 1.0 wt. % (preferably not more than 0.5 wt. %, and more preferably not more than 0.2 wt. %).

Examples of the above-described base polymer include, but are not especially limited to, an acrylic polymer contained in an acrylic pressure-sensitive adhesive layer as the base polymer, a rubber-based polymer contained in a rubber-based pressure-sensitive adhesive layer (a natural rubber-based pressure-sensitive adhesive layer, a synthetic rubber-based pressure-sensitive adhesive layer etc.) as the base polymer, a silicon-based polymer contained in a silicon-based pressure-sensitive adhesive layer as the base polymer, a polyester-based polymer contained in a polyester-based pressure-sensitive adhesive layer as the base polymer, a urethane-based polymer contained in a urethane-based pressure-sensitive adhesive layer as the base polymer, a polyamide-based polymer contained in a polyamide-based pressure-sensitive adhesive layer as the base polymer, an epoxy-based polymer contained in an epoxy-based pressure-sensitive adhesive layer as the base polymer, a vinyl alkyl ether-based polymer contained in a vinyl alkyl ether-based pressure-sensitive adhesive layer as the base polymer, and a fluoropolymer contained in a fluorine-based pressure-sensitive adhesive layer as the base polymer. Among these, in terms of transparency, weatherability, adhesion reliability, and ease of designing the functions of the pressure-sensitive adhesive layer due to the wide availability of types of monomer, the base polymer is preferably an acrylic polymer. Specifically, the above-described pressure-sensitive adhesive layer is preferably an acrylic pressure-sensitive adhesive layer that contains the below-described acrylic polymer (A) as the base polymer. The above-mentioned polymers can be used singly or in combinations of two or more as the base polymer.

Although the content of the base polymer in the above-described pressure-sensitive adhesive layer (pressure-sensitive adhesive layer formed from the pressure-sensitive adhesive composition according to the present invention) is not especially limited, it is preferably not less than 75 wt. % (e.g., 75 to 99.9 wt. %), and more preferably not less than 85 wt. % (e.g., 85 to 99.9 wt. %).

The above-described pressure-sensitive adhesive layer includes no or substantially no acid group-containing monomer (e.g., a carboxyl group-containing monomer, a sulfo group-containing monomer, a phosphate group-containing monomer). Consequently, the pressure-sensitive adhesive layer can obtain an excellent corrosion inhibition effect on metal wiring. The pressure-sensitive adhesive layer can be said to contain substantially no acid group-containing monomer if the content of the acid group-containing monomer is, based on the total amount of the above-described pressure-sensitive adhesive layer, not more than 0.05 wt. % (e.g., 0 to 0.05 wt. %), preferably not more than 0.01 wt. % (e.g., 0 to 0.01 wt. %), and more preferably not more than 0.001 wt. % (e.g., 0 to 0.001 wt. %).

If the above-described pressure-sensitive adhesive layer is an acrylic pressure-sensitive adhesive layer, the pressure-sensitive adhesive layer contains no or substantially no acid group-containing monomer, such as a carboxyl group-containing monomer, as a constituent monomer component of the acrylic polymer as the base polymer. If the above-described pressure-sensitive adhesive layer contains an acrylic polymer (A) as the base polymer, it is preferred that the pressure-sensitive adhesive layer contains no or substantially no carboxyl group-containing monomer as a constituent monomer component of the acrylic polymer (A). Such pressure-sensitive adhesive layer can obtain the excellent corrosion inhibition effect. Regarding the meaning of carboxyl group-containing monomer, the meaning of the term “contain substantially no”, and the monomer having an acid group other than a carboxyl group, these are the same as described below with regard to the acrylic polymer (A) and its constituent monomer component. The pressure-sensitive adhesive layer can be said to contain substantially no carboxyl group-containing monomer if the content of the carboxyl group-containing monomer is, based on the total amount of the above-described pressure-sensitive adhesive layer, not more than 0.05 wt. % (e.g., 0 to 0.05 wt. %), preferably not more than 0.01 wt. % (e.g., 0 to 0.01 wt. %), and more preferably not more than 0.001 wt. % (e.g., 0 to 0.001 wt. %).

The above-described pressure-sensitive adhesive layer is transparent, or has a transparency. Consequently, visibility and appearance through the pressure-sensitive adhesive layer are excellent. Thus, the above-described pressure-sensitive adhesive layer (pressure-sensitive adhesive layer formed from the pressure-sensitive adhesive composition according to the present invention) can be preferably employed for optical uses.

Although the haze (based on JIS K7136) of the above-described pressure-sensitive adhesive layer (pressure-sensitive adhesive layer formed from the pressure-sensitive adhesive composition according to the present invention) is not especially limited, it is preferably not more than 1.0%, and more preferably not more than 0.8%. The haze of 1.0% or less is preferable because excellent transparency and excellent appearance are obtained. This haze can be measured using a haze meter (trade name “HM-150”, manufactured by Murakami Color Research Laboratory Co., Ltd.) on a specimen which is, for example, prepared in a manner such that a pressure-sensitive adhesive layer (thickness 100 μm) is laminated on a slide glass (e.g., having a total light transmittance of 91.8% and a haze of 0.4%) after being left for at least 24 hours in an ordinary state (23° C., 50% RH).

Although the total light transmittance (based on JIS K7361-1) of the above-described pressure-sensitive adhesive layer in the visible light wavelength region is not especially limited, it is preferably not less than 85%, and more preferably not less than 88%. The total light transmittance of 85% or more is preferable because excellent transparency and excellent appearance are obtained. This total light transmittance can be measured using a haze meter (trade name “HM-150”, manufactured by Murakami Color Research Laboratory Co., Ltd.) on a specimen which is, for example, prepared in a manner such that a pressure-sensitive adhesive layer (thickness 100 μm) is laminated on a slide glass (e.g., having a total light transmittance of 91.8% and a haze of 0.4%) after being left for at least 24 hours in an ordinary state (23° C., 50% RH).

The method for producing the above-described pressure-sensitive adhesive layer is not especially limited. For example, the pressure-sensitive adhesive layer can be produced by preparing the above-described pressure-sensitive adhesive composition (precursor composition), and optionally performing treatments such as irradiating an active energy ray, and heating and drying. A specific example includes producing the pressure-sensitive adhesive layer by admixing a rust inhibitor (e.g., the below-described benzotriazole-based compound), and optionally additives and the like with a mixture of a monomer component or a partially polymerized product thereof.

The above-described rust inhibitor includes a compound that inhibits rust or corrosion of metal. Examples of the rust inhibitor include, but are not especially limited to, amine compounds, benzotriazole-based compounds, and nitrites. Further examples include ammonium benzoate, ammonium phthalate, ammonium stearate, ammonium palmitate, ammonium oleate, ammonium carbonate, dicyclohexylamine benzoate, urea, urotropine, thiourea, phenyl carbamate, and cyclohexyl ammonium-N-cyclohexyl carbamate (CHC). The rust inhibitors can be used singly or in combinations of two or more.

Examples of the above amine compound include hydroxy group-containing amine compounds, such as 2-amino-2-methyl-1-propanol, monoethanolamine, monoisopropanolamine, diethylethanolamine, ammonia, and ammonia water; cyclic amines, such as morpholine; cyclic alkylamine compounds, such as cyclohexylamine; and straight-chain alkyl amines, such as 3-methoxypropylamine. Examples of the nitrite include dicyclohexyl ammonium nitrite (DICHAN), diisopropyl ammonium nitrite (DIPAN), sodium nitrite, potassium nitrite, and calcium nitrite.

Among these, a benzotriazole-based compound is preferable as a rust inhibitor in terms of compatibility with the base polymer, the transparency, and the fact that, if forming the base polymer after the addition of a rust inhibitor, it is less likely to inhibit the base polymer reactions (cross-linking and polymerization).

Although the content of the above-described rust inhibitor is not especially limited, it is preferably 0.02 to 15 parts by weight based on 100 parts by weight of the base polymer. Further, it is preferred that the rust inhibitor content is 0.02 to 15 parts by weight based on 100 parts by weight of the mixture of the monomer component for constituting the base polymer or a partially polymerized product of that mixture (mixture of the monomer component for constituting the base polymer). It is preferred that the rust inhibitor content is not less than 0.02 parts by weight, because a good corrosion inhibition performance tends to be obtained. On the other hand, it is preferred that the rust inhibitor content is not more than 15 parts by weight, because transparency and adhesion reliability, such as resistance to foaming and release, tend to be obtained.

Especially in terms of enabling adhesion reliability, transparency, and a corrosion inhibition property to be obtained in a good balance and at a high level, and in terms of enabling excellent appearance to be obtained, it is preferred that the above-described base polymer is an acrylic polymer (especially, the below-described acrylic polymer (A)), and that the above-described rust inhibitor is a benzotriazole-based compound. Specifically, it is preferred that the above-described pressure-sensitive adhesive layer is an acrylic pressure-sensitive adhesive layer containing at least an acrylic polymer (especially, the below-described acrylic polymer (A)) as the base polymer, and a benzotriazole-based compound as the rust inhibitor.

### [1-1. Benzotriazole-Based Compound]

Although the content of the benzotriazole-based compound is not especially limited, it is preferably 0.02 to 3 parts by weight, more preferably 0.02 to 2.5 parts by weight, and even more preferably 0.02 to 2 parts by weight based on the total amount (100 parts by weight) of the monomer component for constituting the acrylic polymer (A). Specifically, it is preferred that the above-described pressure-sensitive adhesive layer includes, based on 100 parts by weight of the acrylic polymer (A), 0.02 to 3 parts by weight, more preferably 0.02 to 2.5 parts by weight, and even more preferably 0.02 to 2 parts by weight of the benzotriazole-based compound. Further, since the amount of the benzotriazole-based compound is not more than a predetermined level, adhesion reliability, such as resistance to foaming and release, can be reliably obtained, and an increase in the haze of the pressure-sensitive adhesive sheet can also be reliably prevented.

Although the above-described benzotriazole-based compound is not especially limited as long as it is a compound having a benzotriazole skeleton, it is preferred that the benzotriazole-based compound has a structure represented by the following formula (1) in terms of obtaining a better corrosion inhibition effect.

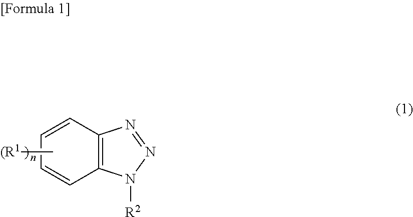

(In formula (1) R¹ and R² may be the same or different, R¹ represents a substituent on the benzene ring, such as an alkyl group having 1 to 6 carbon atoms, an alkoxy group having 1 to 6 carbon atoms, an aryl group having 6 to 14 carbon atoms, an amino group, a mono- or di-C₁₋₁₀alkylamino group, an amino-C₁₋₆alkyl group, a mono- or di-C₁₋₁₀alkylamino-C₁₋₆alkyl group, a mercapto group, an alkoxycarbonyl group having 1 to 6 carbon atoms and n represents an integer of 0 to 4. If n is not less than 2, n R¹s may be the same or different. R² represents a substituent such as a hydrogen atom, an alkyl group having 1 to 12 carbon atoms, an alkoxy group having 1 to 12 carbon atoms, an aryl group having 6 to 14 carbon atoms, an amino group, a mono- or di-C₁₋₁₀alkylamino group, an amino-C₁₋₆alkyl group, a mono- or di-C₁₋₁₀alkylamino-C₁₋₆alkyl group, a mercapto group, an alkoxycarbonyl group having 1 to 12 carbon atoms.)

In terms of obtaining a better corrosion inhibition effect, R¹ is preferably an alkyl group, an alkoxycarbonyl group and the like having 1 to 3 carbon atoms, and a methyl group and the like is more preferable. Further, n is preferably 0 or 1.

In terms of obtaining a better corrosion inhibition effect, R² is preferably a hydrogen atom, a mono- or di-C₁₋₁₀alkylamino-C₁₋₆alkyl group and the like, and a hydrogen atom, a di-C₁₋₈alkylamino-C₁₋₄alkyl group and the like are more preferable.

### [1-2. Acrylic Polymer (A)]

It is preferred that the above-described pressure-sensitive adhesive layer (pressure-sensitive adhesive layer formed from the pressure-sensitive adhesive composition according to the present invention) is an acrylic pressure-sensitive adhesive layer having an acrylic polymer (A) as a main component. Although the specific content of the acrylic polymer (A) is not especially limited, it is preferably not less than 75 wt. % (e.g., 75 to 99.9 wt. %), and more preferably not less than 85 wt. % (e.g., 85 to 99.9 wt. %), based on the total amount of the above-described pressure-sensitive adhesive layer according to the present invention (total weight, 100 wt. %).

Examples of the pressure-sensitive adhesive composition for forming the pressure-sensitive adhesive layer containing the acrylic polymer (A) as a main component include, but are not especially limited to, a composition containing the acrylic polymer (A) as an essential component; and a composition containing a mixture of the monomer component for constituting the acrylic polymer (A) (sometimes referred to as “monomer mixture”) or a partially polymerized product thereof as an essential component. Examples of the former may include, but are not especially limited to, a so-called water dispersion type composition (emulsion type composition). Examples of the latter may include a so-called active energy ray-curable type composition. The pressure-sensitive adhesive composition can optionally include other additives.

The above “monomer mixture” includes cases in which the mixture is formed from a single monomer component and cases in which the mixture is formed from two or more monomer components. Further, the above “partially polymerized product” means a composition obtained by partially polymerizing one monomer component or a plurality of monomer components in the “monomer mixture.” Of these, it is preferred that the above-described pressure-sensitive adhesive composition is a composition containing a monomer mixture or a partially polymerized product thereof as an essential component.

The acrylic polymer (A) is a polymer that includes an acrylic monomer as an essential monomer unit (constituent monomer unit). In other words, the acrylic polymer (A) is a polymer that includes a constituent unit derived from an acrylic monomer as a constituent monomer unit. In other words, the acrylic polymer (A) is a polymer that is constituted (formed) essentially from an acrylic monomer or monomers. In the present specification, “(meth)acrylic” represents either one or both of “acrylic” and “methacrylic”. This is the same for other cases as well. Although the weight average molecular weight of the acrylic polymer (A) is not especially limited, it is preferably 100,000 to 5,000,000.

It is preferred that the acrylic polymer (A) is a polymer that includes an alkyl(meth)acrylate having a straight-chain or branched alkyl group (hereinafter sometimes simply referred to as “alkyl(meth)acrylate”) as an essential monomer unit.

Examples of the above alkyl(meth)acrylate include alkyl(meth)acrylates whose alkyl group has 1 to 20 carbon atoms, such as methyl(meth)acrylate, ethyl(meth)acrylate, propyl(meth)acrylate, isopropyl(meth)acrylate, butyl(meth)acrylate (n-butyl(meth)acrylate), isobutyl(meth)acrylate, s-butyl(meth)acrylate, t-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, isostearyl(meth)acrylate, nonadecyl(meth)acrylate, and eicosyl(meth)acrylate. The alkyl(meth)acrylates can be used singly or in combinations of two or more.

Among these, in terms of obtaining strong adhesion and adjusting the residual stress, the above-described alkyl(meth)acrylate is preferably an alkyl(meth)acrylate whose alkyl group has 1 to 18 carbon atoms, and more preferably is methyl methacrylate (MMA), butyl acrylate (BA), 2-ethylhexyl acrylate (2EHA), or isostearyl acrylate (ISTA).

Although the content (ratio) of the above-described alkyl(meth)acrylate in all the monomer units of the acrylic polymer (A) (the total amount of the monomer component for constituting the acrylic polymer (A)) is not especially limited, the content is preferably 30 to 95 parts by weight, more preferably 35 to 90 parts by weight, and even more preferably 40 to 85 parts by weight, based on the total amount (100 parts by weight) of the monomer component for constituting the acrylic polymer (A), in terms of adhesion reliability, and especially adhesion reliability at low-temperatures.

In addition to the above-described alkyl(meth)acrylate as a monomer unit, the acrylic polymer (A) may also include a monomer that can be copolymerized (a copolymerizable monomer). Specifically, the acrylic polymer (A) may include a copolymerizable monomer as a constituent monomer component. The copolymerizable monomers can be used singly or in combinations of two or more.

Preferred examples of the above copolymerizable monomer include a hydroxyl group-containing monomer. If the acrylic polymer (A) includes a hydroxyl group-containing monomer as a monomer unit, polymerization occurs more easily when polymerizing the constituent monomer component, and it is easier to obtain good cohesion. Consequently, it is easier to obtain strong adhesion, and to increase the gel fraction, which makes it easier to obtain an excellent resistance to foaming and release. In addition, it is easier to suppress whitening of the pressure-sensitive adhesive sheet, which can occur under a high-humidity environment. The above-described rust inhibitors have selectivity in the solubility in a monomer. For example, a benzotriazole-based compound which is one of the above-described rust inhibitors has good solubility in a hydroxy group-containing monomer.

The content (ratio) of the above-described hydroxyl group-containing monomer based on the total amount (100 parts by weight) of the monomer component for constituting the acrylic polymer (A) is not especially limited. If the amount of the hydroxyl group-containing monomer is not less than a predetermined level, whitening of the pressure-sensitive adhesive sheet, which can occur under a high-humidity environment, can be better suppressed, and transparency, such as humid cloudiness resistance, can be obtained. A lower limit for the content of the hydroxyl group-containing monomer is preferably not less than 5 parts by weight, more preferably not less than 7 parts by weight, and even more preferably not less than 10 parts by weight. Further, an upper limit for the content of the hydroxyl group-containing monomer is preferably not more than 40 parts by weight, more preferably not more than 35 parts by weight, and even more preferably not more than 30 parts by weight, in terms of cohesion and easily obtaining adhesion reliability, such as adhesion and resistance to foaming and release.

In addition, a preferred example of the above-described copolymerizable monomer is a nitrogen atom-containing monomer. If the acrylic polymer (A) includes a nitrogen atom-containing monomer as a monomer unit, a suitable cohesion tends to be obtained. Consequently, the 180° (degrees) peel adhesion strength to a glass plate and the 180° peel adhesion strength to an acrylic plate tend to increase, so that a strong adhesion tends to be obtained. Further, the gel fraction tends to increase, which makes it easier to obtain an excellent resistance to foaming and release. In addition, a suitable flexibility for the pressure-sensitive adhesive layer tends to be obtained, so that an excellent stress relaxation property and excellent step conformability or step absorbability tend to be obtained by adjusting the 300% tension residual stress to within a specific range. The above-described rust inhibitors have selectivity in the solubility in a monomer. For example, a benzotriazole-based compound which is one of the above-described rust inhibitors has good solubility in a nitrogen atom-containing monomer.

Although the content (ratio) of the above-described nitrogen atom-containing monomer based on the total amount (100 parts by weight) of the monomer component for constituting the acrylic polymer (A) is not especially limited, it is preferably not less than 5 parts by weight. A lower limit for the content of the nitrogen atom-containing monomer is more preferably not less than 7 parts by weight, and even more preferably not less than 10 parts by weight, based on the total amount (100 parts by weight) of the monomer component for constituting the acrylic polymer (A), in terms of cohesion, adhesion, and resistance to foaming and release. Further, an upper limit for the content of the nitrogen atom-containing monomer is preferably not more than 40 parts by weight, more preferably not more than 35 parts by weight, and even more preferably not more than 30 parts by weight, in terms of more easily obtaining suitable flexibility for the pressure-sensitive adhesive layer, an excellent stress relaxation property, and excellent step conformability.

The above-described acrylic polymer (A) can be obtained by polymerizing the above-described monomer unit (monomer component) by a known or customary polymerization method. Examples of the method for forming the above-described acrylic polymer (A) include solution polymerization, emulsion polymerization, bulk polymerization, and polymerization by irradiating with an active energy ray (active energy ray polymerization). Among these, in terms of the transparency of the pressure-sensitive adhesive layer, moisture resistance, and cost, solution polymerization and active energy ray polymerization are preferred, and more preferred is active energy ray polymerization.

Examples of the active energy ray irradiated during the above-described active energy ray polymerization (photopolymerization) include ionizing radiation, such as α-rays, β-rays, γ-rays, neutron rays, and an electron ray, and UV-rays. UV-rays are especially preferred. Further, the irradiation energy, the irradiation time, the irradiation method and the like of the active energy ray are not especially limited, as long as they can activate a photopolymerization initiator to occur the reaction.

Various kinds of common solvents may be used for the polymerization of the above-described acrylic polymer (A). Examples of such solvents include organic solvents, for instance esters, such as ethyl acetate and n-butyl acetate; aromatic hydrocarbons, such as toluene and benzene; aliphatic hydrocarbons, such as n-hexane and n-heptane; alicyclic hydrocarbons, such as cyclohexane and methylcyclohexane; and ketones, such as methyl ethyl ketone and methyl isobutyl ketone. The solvents can be used singly or in combinations of two or more.

Further, for polymerization of the acrylic polymer (A), a polymerization initiator, such as a thermal polymerization initiator and a photopolymerization initiator (photoinitiator) may be used according to the type of polymerization reaction. The polymerization initiators can be used singly or in combinations of two or more.

Examples of the above-described photopolymerization initiator include, but are not especially limited to, a benzoin ether photopolymerization initiator, an acetophenone photopolymerization initiator, an α-ketol photopolymerization initiator, an aromatic sulfonyl chloride photopolymerization initiator, an optically-active oxime-based photopolymerization initiator, a benzoin-based photopolymerization initiator, a benzyl-based photopolymerization initiator, a benzophenone photopolymerization initiator, a ketal-based photopolymerization initiator, and a thioxanthone photopolymerization initiator. The photopolymerization initiators can be used singly or in combinations of two or more.

Examples of the above benzoin ether photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one, and anisole methyl ether. Examples of the above acetophenone photopolymerization initiator include 2,2-diethoxyacetophenone, 2,2-dimethoxy-2-phenylacetophenone, 1-hydroxycyclohexylphenyl ketone, 4-phenoxydichloroacetophenone, and 4-(t-butyl)dichloroacetophenone. Examples of the above α-ketol photopolymerization initiator include 2-methyl-2-hydroxypropiophenone and 1-[4-(2-hydroxyethyl)phenyl]-2-methyl propan-1-one. Examples of the aromatic sulfonyl chloride photopolymerization initiator include 2-naphthalenesulfonyl chloride. Examples of the optically-active oxime-based photopolymerization initiator include 1-phenyl-1,1-propanedion-2-(o-ethoxycarbonyl)-oxime. Examples of the benzoin-based photopolymerization initiator include benzoin. Examples of the benzyl-based photopolymerization initiator include benzyl. Examples of the benzophenone photopolymerization initiator include benzophenone, benzoyl benzoic acid, 3,3′-dimethyl-4-methoxybenzophenone, polyvinyl benzophenone, and α-hydroxycyclohexyl phenyl ketone. Examples of the ketal-based photopolymerization initiator include benzyl dimethyl ketal. Examples of the thioxanthone photopolymerization initiator include thioxanthone, 2-chlorothioxanthone, 2-methylthioxanthone, 2,4-dimethylthioxanthone, isopropylthioxanthone, and 2,4-diisopropylthioxanthone, dodecylthioxanthone.

Although the amount of the above-described photopolymerization initiator used is not especially limited, for example, the amount used is preferably 0.001 to 1 part by weight, and more preferably 0.01 to 0.50 parts by weight, based on 100 parts by weight of all the monomer units of the acrylic polymer (A) (total amount of the monomer component for constituting the acrylic polymer (A)).

Examples of the above-described thermal polymerization initiator include, but are not especially limited to, an azo polymerization initiator, a peroxide polymerization initiator (e.g., dibenzoyl peroxide, tert-butyl permaleate), and a redox polymerization initiator. Among these, an azo polymerization initiator disclosed in Japanese Patent Laid-Open No. 2002-69411 is preferred. Examples of the azo polymerization initiator include 2,2′-azobisisobutyronitrile (hereinafter sometimes referred to as “AIBN”), 2,2′-azobis-2-methylbutyronitrile (hereinafter sometimes referred to as “AMBN”), dimethyl 2,2′-azobis(2-methylpropionate), and 4,4′-azobis-4-cyano valeric acid.

Although the amount of the above-described thermal polymerization initiator used is not especially limited, for example, for the above-described azo polymerization initiator, the amount used is preferably 0.05 to 0.5 parts by weight, and more preferably 0.1 to 0.3 parts by weight, based on 100 parts by weight of all the monomer units of the acrylic polymer (A) (total amount of the monomer component for constituting the acrylic polymer (A)).

### [1-3. Carboxyl Group-Containing Monomer etc.]

The above-described pressure-sensitive adhesive layer contains no or substantially no acid group-containing monomer as the monomer component for constituting the base polymer. If the above-described pressure-sensitive adhesive layer is an acrylic pressure-sensitive adhesive layer, it is preferred that the pressure-sensitive adhesive layer contains substantially no carboxyl group-containing monomer as the monomer component for constituting the acrylic polymer (A). The term “contain substantially no” refers to not being artificially added with such a monomer, excluding cases in which such a carboxyl group-containing monomer is inevitably contained. Further, a carboxyl group-containing monomer means a monomer having at least one carboxyl group in the molecule. In terms of the fact that a better corrosion inhibition effect can be obtained, the content of a carboxyl group-containing monomer in the adhesive layer is preferably not more than 0.05 parts by weight (e.g., 0 to 0.05 parts by weight), more preferably not more than 0.01 parts by weight (e.g., 0 to 0.01 parts by weight), and even more preferably not more than 0.001 parts by weight (e.g., 0 to 0.001 parts by weight), based on the total amount (100 parts by weight) of the monomer component for constituting the acrylic polymer (A). The pressure-sensitive adhesive layer with such carboxyl group-containing monomer content can be said to contain substantially no carboxyl group-containing monomer. Further, examples of the above-described carboxyl group-containing monomer include (meth)acrylic acid, itaconic acid, maleic acid, fumaric acid, crotonic acid, and isocrotonic acid. In addition, the above-described carboxyl group-containing monomer may include, for example, an acid anhydride group-containing monomer, such as maleic anhydride and itaconic anhydride.

Further, if the above-described pressure-sensitive adhesive layer is an acrylic pressure-sensitive adhesive layer, it is preferred, in terms of better corrosion inhibition effect, that the pressure-sensitive adhesive layer contains substantially no monomer having an acid group other than a carboxyl group (e.g., a sulfo group, a phosphate group) as the monomer component for constituting the acrylic polymer (A), as well as it contains substantially no carboxyl group-containing monomer. In other words, it is preferred that the acrylic polymer (A) includes substantially no monomer having another acid group as the constituent monomer component, as well as it includes substantially no carboxyl group-containing monomer. Specifically, the pressure-sensitive adhesive layer can be said to contain substantially no carboxyl group-containing monomer or another acid group-containing monomer if the total amount of the carboxyl group-containing monomer and the another acid group-containing monomer as the monomer component for constituting the acrylic polymer (A) is not more than 0.05 parts by weight (e.g., 0 to 0.05 parts by weight), preferably not more than 0.01 parts by weight (e.g., 0 to 0.01 parts by weight), and more preferably not more than 0.001 parts by weight (e.g., 0 to 0.001 parts by weight), based on the total amount (100 parts by weight) of the monomer component for constituting the acrylic polymer (A).

In terms of better corrosion inhibition effect, it is preferred that the above-described pressure-sensitive adhesive layer contains no or substantially no acid group-containing monomer even as the monomer component for constituting a polymer other than the acrylic polymer (A) (e.g., the below-described acrylic polymer (B)). For example, it is preferred that the pressure-sensitive adhesive layer contains no or substantially no carboxyl group-containing monomer. Regarding the meaning of the term “contain substantially no”, the preferred level, and the monomer having an acid group other than a carboxyl group, these are the same as described above with regard to the acrylic polymer (A) and its constituent monomer component.

### [1-4. Basic Group-Containing Monomer]

It is preferred that the above-described pressure-sensitive adhesive layer contains no or substantially no basic group-containing monomer as the monomer component for constituting the base polymer. If the above-described pressure-sensitive adhesive layer is an acrylic pressure-sensitive adhesive layer containing the acrylic polymer (A) as a base polymer, it is preferred that the pressure-sensitive adhesive layer contains substantially no basic group-containing monomer as the monomer component for constituting a polymer other than the acrylic polymer (A). It is preferred that the pressure-sensitive adhesive layer contains substantially no basic group-containing monomer even as a monomer not forming polymers, which is the same as for the case of the carboxyl group-containing monomer. For the basic group-containing monomer, the meaning of the term “contain substantially no”, the preferred level and the like are also the same as for the case of the carboxyl group-containing monomer.

### [1-5. Hydroxyl Group-Containing Monomer]

A hydroxyl group-containing monomer means a monomer having at least one hydroxyl group in the molecule. Further, a monomer having at least one hydroxyl group in the molecule and at least one carboxyl group in the molecule is considered here to be a carboxyl group-containing monomer, not a hydroxyl group-containing monomer. Examples of the hydroxyl group-containing monomer include, but are not especially limited to, specifically, hydroxyl group-containing (meth)acrylates, such as 2-hydroxyethyl(meth)acrylate, 2-hydroxypropyl(meth)acrylate, 2-hydroxybutyl(meth)acrylate, 3-hydroxypropyl(meth)acrylate, 4-hydroxybutyl(meth)acrylate, 6-hydroxyhexyl(meth)acrylate, hydroxyoctyl(meth)acrylate, hydroxydecyl(meth)acrylate, hydroxylauryl(meth)acrylate, (4-hydroxymethylcyclohexyl)(meth)acrylate; vinyl alcohol and allyl alcohol. Among these, in terms of improving the compatibility of the benzotriazole-based compound, the above-described hydroxyl group-containing monomer is preferably a hydroxyl group-containing (meth)acrylate, and more preferably is 2-hydroxyethyl acrylate (HEA), 2-hydroxypropyl(meth)acrylate (HPA), and 4-hydroxybutyl acrylate (4HBA). The hydroxyl group-containing monomers can be used singly or in combinations of two or more.

### [1-6. Nitrogen Atom-Containing Monomer]

A nitrogen atom-containing monomer means a monomer having at least one nitrogen atom in the molecule (in one molecule). However, here, the nitrogen atom-containing monomer is not considered to be included in the above-described hydroxyl group-containing monomer. Specifically, in the present specification, a monomer that has a hydroxyl group and a nitrogen atom in the molecule is considered to be a nitrogen atom-containing monomer. Further, a monomer having at least one nitrogen atom in the molecule and at least one carboxyl group in the molecule is considered to be a carboxyl group-containing monomer, not a nitrogen atom-containing monomer.

In terms of improving resistance to foaming and release, the nitrogen atom-containing monomer is preferably an N-vinyl cyclic amide, a (meth)acrylamide and the like. The nitrogen atom-containing monomers can be used singly or in combinations of two or more.

In terms of improving the compatibility of the benzotriazole-based compound, the N-vinyl cyclic amide is preferably an N-vinyl cyclic amide represented by the following formula (2).

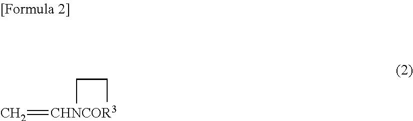

(In formula (2), R³ represents a divalent organic group.)

R³ in formula (2) represents a divalent organic group. Preferably, R³ is a divalent saturated hydrocarbon group or a divalent unsaturated hydrocarbon group, and more preferably a divalent saturated hydrocarbon group (e.g., an alkylene group having 3 to 5 carbon atoms).

In addition, in terms of improving resistance to foaming and release and the compatibility of the benzotriazole-based compound, the N-vinyl cyclic amide represented by the above formula (2) is preferably N-vinyl-2-pyrrolidone (NVP), N-vinyl-2-piperidone, N-vinyl-2-caprolactam, N,N-dimethyl(meth)acrylamide, N,N-diethyl(meth)acrylamide, N-vinyl-3-morpholinone, N-vinyl-1,3-oxazin-2-one, and N-vinyl-3,5-morpholinedione, more preferably N-vinyl-2-pyrrolidone, N-vinyl-2-caprolactam, N,N-dimethyl(meth)acrylamide, and N,N-diethyl(meth)acrylamide, and even more preferably N-vinyl-2-pyrrolidone.

Examples of the above-described (meth)acrylamide include (meth)acrylamide, N-alkyl(meth)acrylamide, and N,N-dialkyl(meth)acrylamide. Examples of the above-described N-alkyl(meth)acrylamide include N-ethyl(meth)acrylamide, N-isopropyl(meth)acrylamide, N-n-butyl(meth)acrylamide, and N-octyl acrylamide. Further, above-described N-alkyl(meth)acrylamide may be a (meth)acrylamide having an amino group, such as dimethylaminoethyl(meth)acrylamide, diethylaminoethyl(meth)acrylamide, and dimethylaminopropyl(meth)acrylamide. Examples of the above-described N,N-dialkyl(meth)acrylamide include N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide, and N,N-di(t-butyl)(meth)acrylamide.

Further, the above-described (meth)acrylamide may also be, for example, various N-hydroxyalkyl(meth)acrylamides. Examples of such an N-hydroxyalkyl(meth)acrylamide include N-methylol(meth)acrylamide, N-(2-hydroxyethyl)(meth)acrylamide, N-(2-hydroxypropyl)(meth)acrylamide, N-(1-hydroxypropyl)(meth)acrylamide, N-(3-hydroxypropyl)(meth)acrylamide, N-(2-hydroxybutyl)(meth)acrylamide, N-(3-hydroxybutyl)(meth)acrylamide, N-(4-hydroxybutyl)(meth)acrylamide, and N-methyl-N-2-hydroxyethyl(meth)acrylamide.

In addition, the above-described (meth)acrylamide may also be, for example, various N-alkoxyalkyl(meth)acrylamides. Examples of such an N-alkoxyalkyl(meth)acrylamide include N-methoxymethyl(meth)acrylamide and N-butoxymethyl(meth)acrylamide.

Still further, examples of nitrogen atom-containing monomers other than the above-described N-vinyl cyclic amides and the above-described (meth)acrylamides include amino group-containing monomers, such as aminoethyl(meth)acrylate, dimethylaminoethyl(meth)acrylate, dimethylaminopropyl(meth)acrylate, and t-butylaminoethyl(meth)acrylate; cyano group-containing monomers, such as acrylonitrile and methacrylonitrile; heterocyclic ring-containing monomers, such as (meth)acryloyl morpholine, N-vinyl piperazine, N-vinyl pyrrole, N-vinyl imidazole, N-vinyl pyrazine, N-vinyl morpholine, N-vinyl pyrazole, vinyl pyridine, vinyl pyrimidine, vinyl oxazole, vinyl isoxazole, vinyl thiazole, vinyl isothiazole, vinyl pyridazine, (meth)acryloyl pyrrolidone, (meth)acryloyl pyrrolidine, (meth)acryloyl piperidine, and N-methylvinylpyrrolidone; imide group-containing monomers, for example, maleimide monomers, such as N-cyclohexyl maleimide, N-isopropyl maleimide, N-lauryl maleimide, and N-phenyl maleimide, itaconimide monomers, such as N-methylitaconimide, N-ethylitaconimide, N-butylitaconimide, N-octylitaconimide, N-2-ethylhexylitaconimide, N-laurylitaconimide, and N-cyclohexylitaconimide, and succinimide monomers, such as N-(meth)acryloyloxymethylenesuccinimide, N-(meth)acryloyl-6-oxyhexamethylenesuccinimide, and N-(meth)acryloyl-8-oxyoctamethylenesuccinimide; and isocyanate group-containing monomers, such as 2-(meth)acryloyloxyethyl isocyanate.

### [1-7. Other Copolymerizable Monomers]

In addition to the above-described nitrogen atom-containing monomer and hydroxyl group-containing monomer, further examples of the copolymerizable monomer in the acrylic polymer (A) include alkoxyalkyl ester(meth)acrylates [e.g., 2-methoxyethyl(meth)acrylate, 2-ethoxyethyl(meth)acrylate, methoxy triethylene glycol(meth)acrylate, 3-methoxypropyl(meth)acrylate, 3-ethoxypropyl(meth)acrylate, 4-methoxybutyl(meth)acrylate, 4-ethoxybutyl(meth)acrylate]; epoxy group-containing monomers [e.g., glycidyl(meth)acrylate, methylglycidyl(meth)acrylate]; sulfonate group-containing monomers [e.g., sodium vinyl sulfonate]; phosphate group-containing monomers; (meth)acrylates having an alicyclic hydrocarbon group [e.g., cyclopentyl(meth)acrylate, cyclohexyl(meth)acrylate, isobornyl(meth)acrylate]; (meth)acrylates having an aromatic hydrocarbon group [e.g., phenyl(meth)acrylate, phenoxyethyl(meth)acrylate, benzyl(meth)acrylate]; vinyl esters [e.g., vinyl acetate, vinyl propionate]; aromatic vinyl compounds [e.g., styrene, vinyl toluene]; olefins or dienes [e.g., ethylene, propylene, butadiene, isoprene, isobutylene]; vinyl ethers [e.g., vinyl alkyl ether]; and vinyl chlorides.

Further examples of the copolymerizable monomer in the acrylic polymer (A) include a polyfunctional monomer. The polyfunctional monomer is used as a crosslinking component. Examples of the polyfunctional monomer include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxy acrylate, polyester acrylate, and urethane acrylate. The polyfunctional monomers can be used singly or in combinations of two or more.

Although the content (ratio) of the polyfunctional monomer in all the monomer units of the acrylic polymer (A) is not especially limited, the content is preferably not more than 0.5 parts by weight (e.g., 0 to 0.5 parts by weight), more preferably 0 to 0.35 parts by weight, and even more preferably 0 to 0.2 parts by weight, based on the total amount (100 parts by weight) of the monomer component for constituting the acrylic polymer (A). It is preferred that the content of the polyfunctional monomer is not more than 0.5 parts by weight, because the pressure-sensitive adhesive layer tends to have suitable cohesion, and the adhesion strength and step conformability tend to improve. If a crosslinking agent is used, it is not necessary to use a polyfunctional monomer. When a crosslinking agent is not used, the content of the polyfunctional monomer is preferably 0.001 to 0.5 parts by weight, more preferably 0.001 to 0.35 parts by weight, and even more preferably 0.002 to 0.2 parts by weight.

### [1-8. Acrylic Polymer (B)]

If the above-described pressure-sensitive adhesive layer (pressure-sensitive adhesive layer formed from the pressure-sensitive adhesive composition according to the present invention) contains the acrylic polymer (A) as a base polymer, it is preferred that the pressure-sensitive adhesive layer contains an acrylic polymer (B) having a weight average molecular weight of 1,000 to 30,000 in addition to the acrylic polymer (A). As a result of containing the acrylic polymer (B), adhesion to an adherend at the interface between the pressure-sensitive adhesive sheet and adherend improves, so that strong adhesion and an excellent resistance to foaming and release tend to be obtained. In the present specification, the “acrylic polymer (B) having a weight average molecular weight of 1,000 to 30,000” is sometimes simply referred to as “acrylic polymer (B).”

Preferred examples of the acrylic polymer (B) include acrylic polymers formed from a (meth)acrylate having a ring structure in the molecule as an essential monomer component. More preferred examples include acrylic polymers formed from a (meth)acrylate having a ring structure in the molecule and an alkyl(meth)acrylate having a straight-chain or branched alkyl group as an essential monomer component. Specifically, preferred examples of the acrylic polymer (B) include acrylic polymers that include, as a monomer unit, a (meth)acrylate having a ring structure in the molecule, and more preferred examples include acrylic polymers that include, as a monomer unit, a (meth)acrylate having a ring structure in the molecule and an alkyl(meth)acrylate having a straight-chain or branched alkyl group.

The ring structure (ring) of the (meth)acrylate having a ring structure in the molecule (in one molecule) (hereinafter sometimes referred to as “ring-containing (meth)acrylate”) is not especially limited, and may be either an aromatic ring or a non-aromatic ring. Examples of aromatic rings include an aromatic carbon ring [e.g., a monocyclic carbon ring such as a benzene ring, a fused carbon ring such as a naphthalene ring] and various aromatic heterocyclic rings. Examples of non-aromatic rings include a non-aromatic aliphatic ring (a non-aromatic alicyclic ring) [e.g., a cycloalkane ring such as a cyclopentane ring, a cyclohexane ring, a cycloheptane ring, and a cyclooctane ring; a cycloalkene ring such as a cyclohexene ring], non-aromatic crosslinked rings [e.g., an alicyclic hydrocarbon ring (a crosslinked hydrocarbon ring), for example, a bicyclic hydrocarbon ring in pinane, pinene, bornane, norbornane, norbornene etc.; a tricyclic or more aliphatic hydrocarbon ring in adamantane etc.], and a non-aromatic heterocyclic ring [e.g., an epoxy ring, an oxolane ring, an oxetane ring].

Examples of the above-described tricyclic or more aliphatic hydrocarbon ring (a tricyclic or more crosslinked hydrocarbon ring) include a dicyclopentanyl group represented by the following formula (3a), a dicyclopentenyl group represented by the following formula (3b), an adamantyl group represented by the following formula (3c), a tricyclopentanyl group represented by the following formula (3d), and a tricyclopentenyl group represented by the following formula (3e).

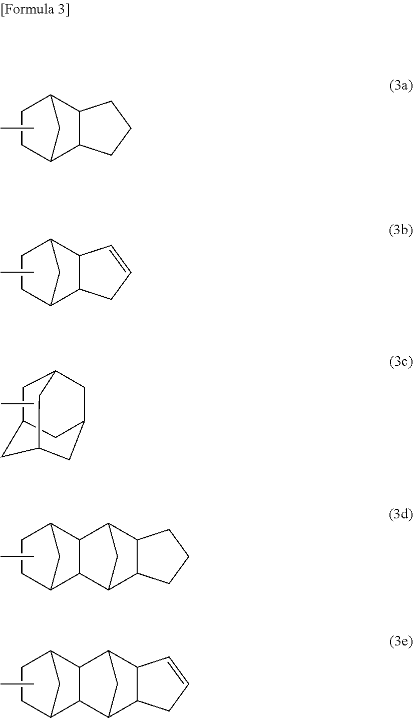

Specifically, examples of the ring-containing (meth)acrylate include a cycloalkyl(meth)acrylate, such as cyclopentyl(meth)acrylate, cyclohexyl(meth)acrylate, cycloheptyl(meth)acrylate, and cyclooctyl(meth)acrylate; a (meth)acrylate having a bicyclic aliphatic hydrocarbon ring, such as isobornyl(meth)acrylate; a (meth)acrylate having a tricyclic or more aliphatic hydrocarbon ring, such as dicyclopentanyl(meth)acrylate, dicyclopentanyloxyethyl(meth)acrylate, tricyclopentanyl(meth)acrylate, 1-adamantyl(meth)acrylate, 2-methyl-2-adamantyl(meth)acrylate, and 2-ethyl-2-adamantyl(meth)acrylate; and a (meth)acrylate having an aromatic ring, such as an aryl(meth)acrylate including phenyl(meth)acrylate, an aryloxyalkyl(meth)acrylate including phenoxyethyl(meth)acrylate, and an arylalkyl(meth)acrylate including benzyl(meth)acrylate. Among these, especially, the ring-containing (meth)acrylate is preferably a non-aromatic ring-containing (meth)acrylate, more preferably cyclohexyl acrylate (CHA), cyclohexyl methacrylate (CHMA), dicyclopentanyl acrylate (DCPA), and dicyclopentanyl methacrylate (DCPMA), and even more preferably dicyclopentanyl acrylate (DCPA) and dicyclopentanyl methacrylate (DCPMA). The ring-containing (meth)acrylates can be used singly or in combinations of two or more.

Among the above-described non-aromatic ring-containing (meth)acrylates, it is preferred to use a (meth)acrylate having a tricyclic or more aliphatic hydrocarbon ring (especially, a tricyclic or more crosslinked hydrocarbon ring), because polymerization inhibition is less likely to occur. Further, if a (meth)acrylate having a dicyclopentanyl group represented by the above formula (3a), an adamantyl group represented by the above formula (3c), or a tricyclopentanyl group represented by the above formula (3d), which do not have an unsaturated bond, is used, the resistance to foaming and release can be increased, and adhesion to a low-polarity adherend, such as polyethylene and polypropylene, can be remarkably improved.

Although the content (ratio) of the above-described ring-containing (meth)acrylate in all the monomer units of the acrylic polymer (B) (the total amount of the monomer component for constituting the acrylic polymer (B)) is not especially limited, the content is preferably 10 to 90 parts by weight, and more preferably 20 to 80 parts by weight, based on the total amount (100 parts by weight) of the monomer component for constituting the acrylic polymer (B). It is preferred that the content of the above-described ring-containing (meth)acrylate is not less than 10 parts by weight, because the resistance to foaming and release tends to improve. Further, it is preferred that this content is not more than 90 parts by weight, because the pressure-sensitive adhesive layer tends to have suitable flexibility, and the pressure-sensitive adhesion strength and step conformability tend to improve.

Further, examples of the above-described alkyl(meth)acrylate having a straight-chain or branched alkyl group as a monomer unit of the acrylic polymer (B) include alkyl(meth)acrylates whose alkyl group has 1 to 20 carbon atoms, such as methyl(meth)acrylate, ethyl(meth)acrylate, propyl(meth)acrylate, isopropyl(meth)acrylate, butyl(meth)acrylate, isobutyl(meth)acrylate, s-butyl(meth)acrylate, t-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, and eicosyl(meth)acrylate. Among these, in terms of good compatibility with the acrylic polymer (A), methyl methacrylate (MMA) is preferred. The alkyl (meth)acrylates can be used singly or in combinations of two or more.

Although the content (ratio) of the above-described alkyl(meth)acrylate having a straight-chain or branched alkyl group in all the monomer units of the acrylic polymer (B) (the total amount of the monomer component for constituting the acrylic polymer (B)) is not especially limited, the content is, in terms of resistance to foaming and release, preferably 10 to 90 parts by weight, more preferably 20 to 80 parts by weight, and even more preferably 20 to 60 parts by weight, based on the total amount (100 parts by weight) of the monomer component for constituting the acrylic polymer (B). It is preferred that the content is not less than 10 parts by weight, because the adhesion strength to adherends made from acrylic resin or polycarbonate tends to improve.

In addition to the above-described ring-containing (meth)acrylate and alkyl(meth)acrylate having a straight-chain or branched alkyl group, the acrylic polymer (B) may also include, as a monomer unit, a monomer (a copolymerizable monomer) that can be copolymerized with these monomers. Although the content (ratio) of the copolymerizable monomer in all the monomer units of the acrylic polymer (B) (the total amount of the monomer component for constituting the acrylic polymer (B)) is not especially limited, the content is preferably not more than 49.9 parts by weight (e.g., 0 to 49.9 parts by weight), and more preferably not more than 30 parts by weight, based on the total amount (100 parts by weight) of the monomer component for constituting the acrylic polymer (B). Further, the copolymerizable monomers can be used singly or in combinations of two or more.

Examples of the above-described copolymerizable monomer as a monomer unit of the acrylic polymer (B) (the above-described copolymerizable monomer forming the acrylic polymer (B)) include alkoxyalkyl ester(meth)acrylates [e.g., 2-methoxyethyl(meth)acrylate, 2-ethoxyethyl(meth)acrylate, methoxy triethylene glycol(meth)acrylate, 3-methoxypropyl(meth)acrylate, 3-ethoxypropyl(meth)acrylate, 4-methoxybutyl(meth)acrylate, 4-ethoxybutyl(meth)acrylate]; hydroxyl group-containing monomers [e.g., hydroxyalkyl(meth)acrylates, such as 2-hydroxyethyl(meth)acrylate, 2-hydroxypropyl(meth)acrylate, 2-hydroxybutyl(meth)acrylate, 3-hydroxypropyl(meth)acrylate, 4-hydroxybutyl(meth)acrylate, and 6-hydroxyhexyl(meth)acrylate, vinyl alcohol, allyl alcohol]; amide group-containing monomers [e.g., (meth)acrylamide, N,N-dimethyl(meth)acrylamide, N-methylol(meth)acrylamide, N-methoxymethyl(meth)acrylamide, N-butoxymethyl(meth)acrylamide, N-hydroxyethyl(meth)acrylamide]; amino group-containing monomers [e.g., aminoethyl(meth)acrylate, dimethylaminoethyl(meth)acrylate, t-butylaminoethyl(meth)acrylate]; cyano group-containing monomers [e.g., acrylonitrile, methacrylonitrile]; sulfonate group-containing monomers [e.g., sodium vinyl sulfonate]; phosphate group-containing monomers [e.g., 2-hydroxyethyl acryloyl phosphate]; isocyanate group-containing monomers [e.g., 2-methacryloyloxyethyl isocyanate], imide group-containing monomers [cyclohexylmaleimide, isopropyl maleimide].

Thus, it is preferred that the acrylic polymer (B) is an acrylic polymer that includes a (meth)acrylate having a ring structure in the molecule and an alkyl(meth)acrylate having a straight-chain or branched alkyl group as the monomer unit. Among these, it is preferred that the acrylic polymer (B) is an acrylic polymer that includes a ring-containing (meth)acrylate and the above-described alkyl(meth)acrylate having a straight-chain or branched alkyl group as the monomer unit. In this acrylic polymer that includes a ring-containing (meth)acrylate and an alkyl(meth)acrylate having a straight-chain or branched alkyl group as the monomer unit, although the content of the ring-containing (meth)acrylate based on the total amount (100 parts by weight) of the monomer component for constituting the acrylic polymer (B) is not especially limited, the content is preferably 10 to 90 parts by weight, and more preferably 20 to 80 parts by weight. Further, although the content of the alkyl(meth)acrylate having a straight-chain or branched alkyl group is not especially limited, the content is preferably 10 to 90 parts by weight, more preferably 20 to 80 parts by weight, and even more preferably 20 to 60 parts by weight.

Further, it is especially preferred that the acrylic polymer (B) includes, as the monomer unit, (1) at least one monomer selected from the group consisting of dicyclopentanyl acrylate, dicyclopentanyl methacrylate, cyclohexyl acrylate, and cyclohexyl methacrylate, and (2) methyl methacrylate. In the acrylic polymer (B) having such an especially preferred specific structure, the content, in all the monomer units of the acrylic polymer (B), of the (1) dicyclopentanyl acrylate, dicyclopentanyl methacrylate, cyclohexyl acrylate, and cyclohexyl methacrylate (if including two or more of these, the amount thereof) is preferably 30 to 70 parts by weight, and the content of the (2) methyl methacrylate is preferably 30 to 70 parts by weight, based on the total amount (100 parts by weight) of the monomer component for constituting the acrylic polymer (B). However, the acrylic polymer (B) is not limited to the above-described specific structure.

The acrylic polymer (B) can be obtained by polymerizing the above-described monomer component by a known or customary polymerization method. Examples of the method for forming the above-described acrylic polymer (B) include solution polymerization, emulsion polymerization, bulk polymerization, and polymerization by irradiating with an active energy ray (active energy ray polymerization). Among these, bulk polymerization and solution polymerization are preferred, and more preferred is solution polymerization.

Various kinds of common solvents may be used for the polymerization of the acrylic polymer (B). Examples of such solvents include organic solvents, for instance esters, such as ethyl acetate and n-butyl acetate; aromatic hydrocarbons, such as toluene and benzene; aliphatic hydrocarbons, such as n-hexane and n-heptane; alicyclic hydrocarbons, such as cyclohexane and methylcyclohexane; and ketones, such as methyl ethyl ketone and methyl isobutyl ketone. The solvents can be used singly or in combinations of two or more.

Further, for polymerization of the acrylic polymer (B), a known or customary polymerization initiator (e.g., a thermal polymerization initiator, a photopolymerization initiator) may be used. The polymerization initiators can be used singly or in combinations of two or more.

Examples of the thermal polymerization initiator include an azo-based initiator such as 2,2′-azobisisobutyronitrile (AIBN), 2,2′-azobis-2-methylbutyronitrile (AMBN), dimethyl 2,2′-azobis(2-methylpropionate), 4,4′-azobis-4-cyanovaleric acid, 2,2′-azobis(4-methoxy-2,4-dimethylvaleronitrile), 2,2′-azobis(2,4-dimethylvaleronitrile), 1,1′-azobis(cyclohexane-1-carbonitrile), and 2,2′-azobis(2,4,4-trimethylpentane); and a peroxide initiator, such as benzoylperoxide, t-butylhydroperoxide, di-t-butylperoxide, t-butylperoxybenzoate, dicumylperoxide, 1,1-bis(t-butylperoxy)-3,3,5-trimethylcyclohexane, and 1,1-bis(t-butylperoxy)cyclododecane. If solution polymerization is carried out, it is preferred that an oil-soluble polymerization initiator is used. The thermal polymerization initiators can be used singly or in combinations of two or more.

Although the amount of the thermal polymerization initiator used is not especially limited, for example, the amount used may be 0.1 to 15 parts by weight based on 100 parts by weight of all the monomer units (total amount of the monomer component for constituting the acrylic polymer (B)) of the acrylic polymer (B).

Further, the above-described photopolymerization initiator is not especially limited, and examples thereof may include the same photopolymerization initiators used for the polymerization of the acrylic polymer (A) that are described above. The amount of the photopolymerization initiator used is not especially limited, and may be appropriately selected.

In the polymerization of the acrylic polymer (B), to adjust the molecular weight (specifically, to adjust the weight average molecular weight to 1,000 to 30,000), a chain transfer agent may be used. Examples of the chain transfer agent include 2-mercaptoethanol, α-thioglycerol, 2,3-dimercapto-1-propanol, octyl mercaptane, t-nonyl mercaptane, dodecyl mercaptane (lauryl mercaptane), t-dodecyl mercaptane, glycidyl mercaptane, thioglycolic acid, methyl thioglycolate, ethyl thioglycolate, propyl thioglycolate, butyl thioglycolate, t-butyl thioglycolate, 2-ethylhexyl thioglycolate, octyl thioglycolate, isooctyl thioglycolate, decyl thioglycolate, dodecyl thioglycolate, a thioglycolic ester of ethyleneglycol, thioglycolic ester of neopentylglycol, thioglycolic ester of pentaerythritol, and an α-methylstyrene dimer. Among these, in terms of suppressing whitening of the pressure-sensitive adhesive sheet due to humidification, α-thioglycerol and methyl thioglycolate are preferable, and α-thioglycerol is especially preferable. The chain transfer agents can be used singly or in combinations of two or more.

Although the content (amount used) of the chain transfer agent is not especially limited, the content is preferably 0.1 to 20 parts by weight, more preferably 0.2 to 15 parts by weight, and even more preferably 0.3 to 10 parts by weight, based on 100 parts by weight of all the monomer units of the acrylic polymer (B) (the total amount of the monomer component for constituting the acrylic polymer (B)). By setting the content (amount used) of the chain transfer agent in the above range, an acrylic polymer having a weight average molecular weight that is controlled to 1,000 to 30,000 can be easily obtained.

The weight average molecular weight (Mw) of the acrylic polymer (B) is 1,000 to 30,000, preferably 1,000 to 20,000, more preferably 1,500 to 10,000, and even more preferably 2,000 to 8,000. Since the weight average molecular weight of the acrylic polymer (B) is not less than 1,000, the adhesion strength and a retention property are improved, and the resistance to foaming and release is improved. On the other hand, since the weight average molecular weight of the acrylic polymer (B) is not more than 30,000, the adhesion strength tends to increase and the resistance to foaming and release is improved.

The weight average molecular weight (Mw) of the acrylic polymer (B) can be determined by a GPC method in terms of standard polystyrene. For example, the weight average molecular weight can be measured using the high-speed GPC apparatus “HPLC-8120 GPC” (manufactured by Tosoh Corporation) under the following conditions.
Column: TSK gel, Super HZM-H/HZ4000/HZ3000/HZ2000
Solvent: Tetrahydrofuran
Flow rate: 0.6 ml/min

Although the glass transition temperature (Tg) of the acrylic polymer (B) is not especially limited, it is preferably 20 to 300° C., more preferably 30 to 300° C., and even more preferably 40 to 300° C. It is preferred that the glass transition temperature of the acrylic polymer (B) is not less than 20° C., because the resistance to foaming and release tends to be improved. Further, it is preferred that the glass transition temperature of the acrylic polymer (B) is not more than 300° C., because the pressure-sensitive adhesive layer has suitable flexibility, a good adhesion strength and a good step conformability tend to be obtained, and excellent adhesion reliability tends to be obtained.

The glass transition temperature (Tg) of the acrylic polymer (B) is a glass transition temperature (theoretical value) represented by the following equation.

1/Tg=W₁/Tg₁+W₂/Tg₂+ . . . +Wₙ/Tgₙ

In the above equation, Tg represents the glass transition temperature (unit: K) of the acrylic polymer (B), Tgᵢ represents the glass transition temperature (unit: K) of a homopolymer of a monomer i (i=1, 2, . . . n), and Wᵢ represents a weight fraction of the monomer i in the total monomer components.

The Tg of a homopolymer of a monomer for forming the acrylic polymer (B) can be selected from the values listed in the following Table 1. The Tg of a homopolymer of a monomer not listed in Table 1 can be selected from the values described in “Polymer Handbook” (3rd Edition, John Wiley & Sons, Inc., 1989). The Tg of a homopolymer of a monomer that is not described even in that publication can be identified in a measurement method as a peaktop temperature of tan δ obtained by a viscoelasticity test.

TABLE 1

| | Composition | Tg [° C.] |
|---|---|---|
| Homopolymer | Methyl Methacrylate (MMA) | 105 |
| | Dicyclopentanyl Methacrylate (DCPMA) | 175 |
| | Dicyclopentanyl Acrylate (DCPA) | 120 |
| | Isobornyl Methacrylate (IBXMA) | 173 |
| | Isobornyl Acrylate (IBXA) | 97 |
| | Cyclohexyl Methacrylate (CHMA) | 66 |
| | 1-Adamantyl Methcrylate (ADMA) | 250 |
| | 1-Adamantyl Acrylate (ADA) | 153 |
| Copolymer | DCPMA/MMA = 60/40 | 144 |

The copolymer “DCPMA/MMA=60/40” in Table 1 means a copolymer having 60 parts by weight of DCPMA and 40 parts by weight of MMA.

When the above-described pressure-sensitive adhesive layer contains the acrylic polymers (A) and (B), although the content of the acrylic polymer (B) is not especially limited, it is preferably 1 to 30 parts by weight, more preferably 2 to 20 parts by weight, and even more preferably 2 to 10 parts by weight based on 100 parts by weight of the acrylic polymer (A). In other words, although the content of the acrylic polymer (B) in the pressure-sensitive adhesive layer is not especially limited, it is preferably 1 to 30 parts by weight, more preferably 2 to 20 parts by weight, and even more preferably 2 to 10 parts by weight, based on 100 parts by weight of all the monomer units of the acrylic polymer (A). Although the content of the acrylic polymer (B) in the pressure-sensitive adhesive layer is not especially limited, it is, for example, preferably 1 to 30 parts by weight, more preferably 2 to 20 parts by weight, and even more preferably 2 to 10 parts by weight, based on 100 parts by weight of the above-described monomer mixture. It is preferred that the content of the acrylic polymer (B) is not less than 1 part by weight, because excellent adhesion and an excellent resistance to foaming and release tend to be obtained. Further, it is preferred that the content of the acrylic polymer (B) is not more than 30 parts by weight, because excellent transparency and adhesion reliability tend to be obtained.

The method for producing the pressure-sensitive adhesive layer containing the acrylic polymers (A) and (B) is not especially limited. For example, this pressure-sensitive adhesive layer is produced via mixture preparation in which a benzotriazole-based compound, an acrylic polymer (B), additives and the like are optionally admixed to a mixture of the monomer component for constituting the acrylic polymer (A), or a partially polymerized product of a mixture of the monomer component for constituting the acrylic polymer (A) (a monomer mixture, or partially polymerized product thereof, for forming the acrylic polymer (A)).

### [1-9. Additives]

To the extent that the characteristics of the present invention are not harmed, the pressure-sensitive adhesive layer may optionally include known additives, such as a crosslinking agent, a crosslinking accelerator, a silane coupling agent, a tackifying resin (rosin derivative, polyterpene resin, petroleum resin, oil-soluble phenol etc.), an antiaging agent, a filler, a colorant (dye or pigment), a UV absorbing agent, an antioxidant, a chain transfer agent, a plasticizer, a softener, a surfactant, and an antistatic agent. Such additives can be used singly or in combinations of two or more.

If the above-described pressure-sensitive adhesive layer contains a crosslinking agent, the base polymer can be crosslinked to increase the gel fraction of the adhesive layer, causing the resistance to foaming and release likely to be improved. For example, since greater control of the gel fraction can be easily obtained by crosslinking the acrylic polymer (especially, the acrylic polymer (A)), it is easier to improve the resistance to foaming and release. Examples of the crosslinking agent include isocyanate crosslinking agents, epoxy crosslinking agents, melamine crosslinking agents, peroxide crosslinking agents, urea crosslinking agents, metal alkoxide-based crosslinking agents, metal chelate-based crosslinking agents, metal salt-based crosslinking agents, carbodiimide-based crosslinking agents, oxazoline-based crosslinking agents, aziridine-based crosslinking agents, and amine crosslinking agents. Among these, if the pressure-sensitive adhesive layer contains the acrylic polymer (A) as the base polymer, an isocyanate crosslinking agent or an epoxy crosslinking agent is preferred, and an isocyanate crosslinking agent is more preferred, in terms of improving the resistance to foaming and release. The crosslinking agents can be used singly or in combinations of two or more.

Examples of isocyanate crosslinking agents (a polyfunctional isocyanate compound) include lower aliphatic polyisocyanates, such as 1,2-ethylene diisocyanate, 1,4-butylenediisocyanate, and 1,6-hexamethylene diisocyanate; alicyclic polyisocyanates, such as cyclopentylene diisocyanate, cyclohexylene diisocyanate, isophorone diisocyanate, hydrogenated tolylene diisocyanate, and hydrogenated xylene diisocyanate; and aromatic polyisocyanates, such as 2,4-tolylene diisocyanate, 2,6-tolylene diisocyanate, 4,4′-diphenylmethane diisocyanate, and xylylene diisocyanate. Further, the isocyanate crosslinking agent may be, for example, a commercially available product, such as a trimethylolpropane/tolylene diisocyanate adduct [trade name “Coronate L”, manufactured by Nippon Polyurethane Industry Co., Ltd.], a trimethylolpropane/hexamethylene diisocyanate adduct [trade name “Coronate HL”, manufactured by Nippon Polyurethane Industry Co., Ltd.], or a trimethylolpropane/xylylene diisocyanate adduct [trade name “Takenate D-110N”, manufactured by Mitsui Chemicals Co., Ltd.].

Examples of epoxy crosslinking agents (a polyfunctional epoxy compound) include N,N,N′,N′-tetraglycidyl-m-xylenediamine, diglycidyl aniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic diglycidyl ester, triglycidyl-tris(2-hydroxyethyl)isocyanurate, resorcin diglycidyl ether, bisphenol-S-diglycidyl ether, and an epoxy resin having two or more epoxy groups in the molecule. The epoxy crosslinking agent may be, for example, a commercially available product, such as “Tetrad C” (trade name) manufactured by Mitsubishi Gas Chemical Company, Inc.

Although the content of the crosslinking agent in the pressure-sensitive adhesive layer is not especially limited, for example, if the pressure-sensitive adhesive layer contains the acrylic polymer (A) as the base polymer, the content of the crosslinking agent in the adhesive layer is preferably 0.001 to 10 parts by weight, and more preferably 0.01 to 5 parts by weight, based on 100 parts by weight of the acrylic polymer (A). It is preferred that the content of the crosslinking agent is not less than 0.001 parts by weight, because the resistance to foaming and release tends to be improved. On the other hand, it is preferred that the content of the crosslinking agent is not more than 10 parts by weight, because the pressure-sensitive adhesive layer has suitable flexibility, and the adhesion strength tends to be improved.

It is preferred that the pressure-sensitive adhesive layer includes a silane coupling agent, because excellent adhesion to glass (especially, excellent adhesion reliability to glass at a high temperature and high humidity) can be easily obtained. Examples of the silane coupling agent include, but are not especially limited to, γ-glycidoxypropyltrimethoxysilane, γ-glycidoxypropyltriethoxysilane, γ-aminopropyltrimethoxysilane, and N-phenyl-aminopropyltrimethoxysilane. Among these, γ-glycidoxypropyltrimethoxysilane is preferable. Further, as the silane coupling agent, for example, a commercially available product, such as “KBM-403” (trade name, manufactured by Shin-Etsu Chemical Co., Ltd.) may be used. The silane coupling agents can be used singly or in combinations of two or more.

Although the content of the silane coupling agent in the pressure-sensitive adhesive layer is not especially limited, for example, if the pressure-sensitive adhesive layer contains the acrylic polymer (A) as the base polymer, the content of the silane coupling agent in the pressure-sensitive adhesive layer is preferably 0.01 to 1 part by weight, and more preferably 0.03 to 0.5 parts by weight, based on 100 parts by weight of the acrylic polymer (A), in terms of improving the adhesion reliability to glass.

### [2. Pressure-Sensitive Adhesive Sheet]

The pressure-sensitive adhesive sheet according to the present invention is not especially limited as long as it has the above-described pressure-sensitive adhesive layer (pressure-sensitive adhesive layer formed from the pressure-sensitive adhesive composition according to the present invention).

The pressure-sensitive adhesive sheet according to the present invention may be a double-sided pressure-sensitive adhesive sheet in which both faces are a pressure-sensitive adhesive layer surface, or may be a single-sided pressure-sensitive adhesive sheet in which only one face is a pressure-sensitive adhesive layer surface. Among these, in terms of bonding two members together, a double-sided pressure-sensitive adhesive sheet is preferred. In the present specification, the definition of “pressure-sensitive adhesive sheet” includes a tape-like object, namely, “pressure-sensitive adhesive tape”. Further, in the present specification, the pressure-sensitive adhesive layer surface is sometimes referred to as “pressure-sensitive adhesive face”.

The pressure-sensitive adhesive sheet according to the present invention may be provided with a separator (release liner) on a pressure-sensitive adhesive face until usage.

The pressure-sensitive adhesive sheet according to the present invention may be a so-called “substrateless type” pressure-sensitive adhesive sheet (hereinafter sometimes referred to as “substrateless pressure-sensitive adhesive sheet”) that does not have a substrate (substrate layer), or may be a pressure-sensitive adhesive sheet that has a substrate (hereinafter sometimes referred to as “pressure-sensitive adhesive sheet with a substrate”). Examples of the substrateless pressure-sensitive adhesive sheet include a double-sided pressure-sensitive adhesive sheet formed from just the above-described pressure-sensitive adhesive layer, and a double-sided pressure-sensitive adhesive sheet formed from the above-described pressure-sensitive adhesive layer and a pressure-sensitive adhesive layer other than the above-described pressure-sensitive adhesive layer (sometimes referred to as “other pressure-sensitive adhesive layer”). On the other hand, examples of the pressure-sensitive adhesive sheet with a substrate include a pressure-sensitive adhesive sheet having the above-described pressure-sensitive adhesive layer on at least one side of the substrate. Of these, a substrateless pressure-sensitive adhesive sheet (substrateless double-sided pressure-sensitive adhesive sheet) is preferred, and a substrateless double-sided pressure-sensitive adhesive sheet formed from just the above-described pressure-sensitive adhesive layer is more preferred. Here, the definition of “substrate (substrate layer)” does not include the separator that is peeled off when the pressure-sensitive adhesive sheet is used (laminated).

It is preferred that the pressure-sensitive adhesive sheet according to the present invention is a substrateless pressure-sensitive adhesive sheet. This is because it is much more meaningful to be able to provide a substrateless pressure-sensitive adhesive sheet with a corrosion inhibition function, since a pressure-sensitive adhesive sheet with a substrate that uses a moisture-proof substrate can already be said to have a certain level of a corrosion inhibition function.

### [2-1. Various Properties of the Pressure-Sensitive Adhesive Sheet]

Although the 180° peel adhesion strength of the pressure-sensitive adhesive sheet according to the present invention to a glass plate (especially, the 180° peel adhesion strength of the pressure-sensitive adhesive face provided by the above-described pressure-sensitive adhesive layer (pressure-sensitive adhesive layer formed from the pressure-sensitive adhesive composition according to the present invention) to a glass plate) is not especially limited, since higher adhesion strength of the adhesive layer to glass can leads sufficient adhesion to a metal surface and an improved corrosion inhibition effect, the 180° peel adhesion strength is preferably not less than 8 N/20 mm, more preferably not less than 10 N/20 mm, even more preferably not less than 12 N/20 mm, and still even more preferably not less than 14 N/20 mm. If the 180° peel adhesion strength of the pressure-sensitive adhesive sheet according to the present invention to a glass plate is not less than a predetermined value, the adhesion to glass and suppressibility of floating at a step are greatly improved. Further, although an upper limit of the 180° peel adhesion strength of the pressure-sensitive adhesive sheet according to the present invention to a glass plate is not especially limited, for example, it is preferably 40 N/20 mm, and preferably 60 N/20 mm. The 180° peel adhesion strength to a glass plate can be determined by the below-described 180° peel adhesion strength measurement method.

Examples of the glass plate include, but are not especially limited to, “Soda Lime Glass #0050”, (trade name, manufactured by Matsunami Glass Ind. Ltd.). Further examples include alkali-free glass and chemically-strengthened glass.

Although the 180° peel adhesion strength of the pressure-sensitive adhesive sheet according to the present invention to an acrylic plate (especially, the 180° peel adhesion strength of the pressure-sensitive adhesive face provided by the above-described pressure-sensitive adhesive layer (pressure-sensitive adhesive layer formed from the pressure-sensitive adhesive composition according to the present invention) to an acrylic plate) is not especially limited, since higher adhesion strength of the adhesive layer to glass can leads sufficient adhesion to a metal surface and an improved corrosion inhibition effect, the 180° peel adhesion strength is preferably not less than 10 N/20 mm, more preferably not less than 12 N/20 mm, and even more preferably not less than 14 N/20 mm. It is preferred that the pressure-sensitive adhesive sheet according to the present invention has an 180° peel adhesion strength to an acrylic plate of not less than 10 N/20 mm, because good adhesion to an acrylic plate and good suppressibility of floating at a step tend to be obtained. Further, although an upper limit of the 180° peel adhesion strength of the pressure-sensitive adhesive sheet according to the present invention to an acrylic plate is not especially limited, for example, it is 40 N/20 mm, and more preferably 60 N/20 mm. The 180° peel adhesion strength to an acrylic plate can be determined by the below-described 180° peel adhesion strength measurement method.

Examples of the acrylic plate include, but are not especially limited to, a PMMA plate (trade name: “Acrylite”, manufactured by Mitsubishi Rayon Co., Ltd.,).

### (A-1. 180° Peel Adhesion Strength Measurement Method)

A pressure-sensitive adhesive sheet is laminated to an adherend, with its adhesive face facing to the adherend, then pressure-bonded by moving a 2-kg roller back and forth once and aged under a 23° C., 50% RH atmosphere for 30 minutes. After the aging, the pressure-sensitive adhesive sheet is peeled off from the adherend under a 23° C., 50% RH atmosphere at a peeling speed of 300 mm/min and a peeling angle of 180° based on JIS 20237, and the 180° peel adhesion strength (N/20 mm) is measured.

### (B. Thickness)

Although the thickness (total thickness) of the pressure-sensitive adhesive sheet according to the present invention is not especially limited, it is preferably 12 to 350 μm, and more preferably 12 to 300 μm. It is preferred to set the thickness to not less than a predetermined value, because peeling is less likely to occur at a step site. Further, it is preferred to set the thickness to be not more than a predetermined value, because an excellent appearance tends to be maintained during production. Here, the thickness of the separator is not included in the thickness of the pressure-sensitive adhesive sheet according to the present invention.

### (C. Haze)

Although the haze (based on JIS K7136) of the pressure-sensitive adhesive sheet according to the present invention is not especially limited, it is preferably not more than 1.0% and more preferably not more than 0.8%. It is preferred that the haze is not more than 1.0%, because excellent transparency and excellent appearance can be obtained. This haze can be measured using a haze meter (trade name “HM-150”, manufactured by Murakami Color Research Laboratory Co., Ltd.) on a specimen which is prepared, for example, in a manner such that a pressure-sensitive adhesive sheet is laminated on a slide glass (e.g., having a total light transmittance of 91.8% and a haze of 0.4%) after being left for at least 24 hours in an ordinary state (23° C., 50% RH) and being separated from a separator if provided.

### (D. Total Light Transmittance)

Although the total light transmittance (based on JIS K7361-1) of the pressure-sensitive adhesive sheet according to the present invention in the visible light wavelength region is not especially limited, it is preferably not less than 85%, and more preferably not less than 88%. It is preferred that the total light transmittance is not less than 85%, because excellent transparency and excellent appearance are obtained. This total light transmittance can be measured using a haze meter (trade name “HM-150”, manufactured by Murakami Color Research Laboratory Co., Ltd.) on a specimen which is prepared, for example, in a manner such that a pressure-sensitive adhesive sheet is laminated on a slide glass (e.g., having a total light transmittance of 91.8% and a haze of 0.4%) after being left for at least 24 hours in an ordinary state (23° C., 50% RH) and being separated from a separator if provided.

### [2-2. Pressure-Sensitive Adhesive Sheet Production Method]

Although the method for producing the pressure-sensitive adhesive sheet according to the present invention is not especially limited, a known or customary method is preferred. For example, if the pressure-sensitive adhesive sheet according to the present invention is a substrateless pressure-sensitive adhesive sheet, the pressure-sensitive adhesive sheet can be obtained by forming the pressure-sensitive adhesive layer on the separator by the above-described method. Further, if the pressure-sensitive adhesive sheet according to the present invention is a pressure-sensitive adhesive sheet with a substrate, the pressure-sensitive adhesive sheet may be obtained by directly forming the pressure-sensitive adhesive layer on the surface of the substrate (direct method), or may be obtained by first forming the pressure-sensitive adhesive layer on the separator, and then transferring (laminating) onto the substrate to provide the pressure-sensitive adhesive layer on the substrate (transfer method).

### [2-3. Pressure-Sensitive Adhesive Layer in the Pressure-Sensitive Adhesive Sheet]

Although the gel fraction (ratio of solvent insoluble matter) of the pressure-sensitive adhesive layer (especially, pressure-sensitive adhesive layer formed from the pressure-sensitive adhesive composition according to the present invention) in the pressure-sensitive adhesive sheet according to the present invention is not especially limited, it is preferably 65 to 99%, more preferably 68 to 95%, and even more preferably 70 to 95%. It is preferred that the gel fraction is not less than 65%, because the cohesion of the pressure-sensitive adhesive layer tends to improve, foaming and release at the interface with an adherend under a high-temperature environment tend to be suppressed, and an excellent resistance to foaming and release tends to be obtained. Further, it is preferred that the gel fraction is not more than 99%, because suitable flexibility can be obtained and adhesion is further improved.

### (Gel Fraction)

Specifically, the gel fraction (ratio of the solvent insoluble matter) is, for example, a value calculated based on the following “method for measuring gel fraction”.

About 0.1 g of the pressure-sensitive adhesive layer is sampled from a pressure-sensitive adhesive sheet, wrapped with a porous tetrafluoroethylene sheet (trade name: “NTF1122”, manufactured by Nitto Denko Corporation) having an average pore size of 0.2 μm, and tied up with a kite string. The weight at this point is measured, and that weight is taken as the weight before dipping Z. The weight before dipping Z is the total weight of the pressure-sensitive adhesive layer (the pressure-sensitive adhesive layer sampled above), the tetrafluoroethylene sheet, and the kite string. The total weight of the tetrafluoroethylene sheet and the kite string is also measured, and this weight is taken as the wrapper weight Y.

Next, the pressure-sensitive adhesive layer wrapped with the tetrafluoroethylene sheet and tied up with kite string (referred to as the “sample”) is placed in a 50 ml vessel filled with ethyl acetate, and then left at 23° C. for 7 days. The sample (after ethyl acetate treatment) is then taken out of the vessel, transferred to an aluminum cup, and dried in a dryer at 130° C. for 2 hours to remove the ethyl acetate. The weight is then measured, and this weight is taken as the weight after dipping X.

The gel fraction is then calculated according to the following formula.

Gel fraction [% (wt. %)]=(X−Y)/(Z−Y)×100

The gel fraction can be controlled based on, for example, the monomer composition and weight average molecular weight of the base polymer (e.g., the acrylic polymer (A)), and the amount of crosslinking agent used (added).

### (300% Tensile Residual Stress)

Although the 300% tensile residual stress of the above-described pressure-sensitive adhesive layer (especially, pressure-sensitive adhesive layer formed from the pressure-sensitive adhesive composition according to the present invention) is not especially limited, it is preferably 7 to 16 N/cm², more preferably 7 to 15 N/cm², and even more preferably 7 to 14 N/cm². It is preferred that the 300% tensile residual stress is not less than 7 N/cm², because a good resistance to foaming and release tends to be obtained. Further, it is preferred that the 300% tensile residual stress is not more than 16 N/cm², because a good stress relaxation property and good step conformability tend to be obtained.

If the pressure-sensitive adhesive sheet according to the present invention has the above-described pressure-sensitive adhesive layer in which the 300% tensile residual stress is within the specific range, an excellent stress relaxation property tends to be obtained, and excellent step conformability tends to be exhibited. For example, good conformability can be exhibited even against large steps (e.g., a step having a height of about 45 μm, especially a step having a height of 20 to 50 μm).

The 300% tensile residual stress is a value (N/cm²) obtained by drawing a pressure-sensitive adhesive layer in a length direction to be stretched (strained) by 300% under a 23° C. environment, achieving that stretch, determining the tensile load applied on the pressure-sensitive adhesive layer after 300 seconds has elapsed from the end of drawing, and dividing this tensile load by the initial cross-sectional area of the pressure-sensitive adhesive layer (the cross-sectional area before drawing). Here, the initial stretch of the pressure-sensitive adhesive layer is 100%.

### (Thickness)

Although the thickness of the above-described pressure-sensitive adhesive layer (especially, the pressure-sensitive adhesive layer formed from the pressure-sensitive adhesive composition according to the present invention) is not especially limited, it is preferably 12 to 350 μm, and more preferably 12 to 300 μm. It is preferred to set the thickness to not less than a predetermined value, because step conformability and adhesion reliability improve. Further, it is preferred to set the thickness to be not more than a predetermined value, because handleability and production properties are especially excellent.

### (Production Method)

Although the production method of the above-described pressure-sensitive adhesive layer is not especially limited, the pressure-sensitive adhesive layer can be produced by, for example, coating (applying) the above-described pressure-sensitive adhesive composition on a substrate or a release liner, and optionally drying or curing, or drying and curing.

In the coating (applying) of the pressure-sensitive adhesive composition, a known coating method can be used. For example, a coater such as a gravure roll coater, a reverse roll coater, a kiss roll coater, a dip roll coater, a bar coater, a knife coater, a spray coater, a comma coater, and a direct coater can be used.

### [2-4. Other Layers of the Pressure-Sensitive Adhesive Sheet]

The pressure-sensitive adhesive sheet according to the present invention may have another layer in addition to the above-described pressure-sensitive adhesive layer. Examples of another layer include another pressure-sensitive adhesive layer (a pressure-sensitive adhesive layer other than the above-described pressure-sensitive adhesive layer (a pressure-sensitive adhesive layer other than the pressure-sensitive adhesive layer formed from the pressure-sensitive adhesive composition according to the present invention)), an intermediate layer, and an undercoat layer. Further, the pressure-sensitive adhesive sheet according to the present invention may have two or more other layers.

### [2-5. Pressure-Sensitive Adhesive Sheet Substrate]

Examples of a substrate when the pressure-sensitive adhesive sheet according to the present invention is a pressure-sensitive adhesive sheet with a substrate include, but are not especially limited to, various optical films, such as a plastic film, an antireflection (AR) film, a polarizing plate, and a retardation plate. Examples of the material of the plastic film and the like include plastic materials, such as polyester resins including polyethylene terephthalate (PET), acrylic resins including polymethyl methacrylate (PMMA), polycarbonate, triacetyl cellulose (TAC), polysulfone, polyarylate, polyimide, polyvinyl chloride, polyvinyl acetate, polyethylene, polypropylene, an ethylene-propylene copolymer, and cyclic olefin-based polymers including “Arton” (trade name, cyclic olefin-based polymer, manufactured by JSR) and “Zeonor” (trade name, cyclic olefin-based polymer, manufactured by Nippon Zeon Co., Ltd.). These plastic materials can be used singly or in combinations of two or more. Further, the “substrate” is a portion laminated to an adherend together with the pressure-sensitive adhesive layer, when the pressure-sensitive adhesive sheet is laminated to the adherend. The separator (release liner) released during use (during lamination) of the pressure-sensitive adhesive sheet is not included in “substrate”.

The substrate is preferably transparent. Although the total light transmittance (based on JIS K7361-1) in the visible light wavelength region of the substrate is not especially limited, it is preferably not less than 85%, and more preferably not less than 88%. Further, although the haze (based on JIS K7136) of the substrate is not especially limited, it is preferably not more than 1.0%, and more preferably not more than 0.8%. Examples of such a transparent substrate include a PET film or a non-oriented film such as “Arton” (trade name) and “Zeonor” (trade name).

Although the thickness of the substrate is not especially limited, it is preferably 12 to 500 μm, for example. The substrate may be in the form of a single layer or multilayer. Further, the surface of the substrate may be appropriately subjected to a known or customary surface treatment, such as a physical treatment such as a corona discharge treatment and a plasma treatment, and a chemical treatment such as an undercoat treatment, for example.

### [2-6. Pressure-Sensitive Adhesive Sheet Separator]

The pressure-sensitive adhesive sheet according to the present invention may be provided with a separator (release liner) on the pressure-sensitive adhesive face until usage. If the pressure-sensitive adhesive sheet according to the present invention is a double-sided pressure-sensitive adhesive sheet, its pressure-sensitive adhesive faces may be protected with respective separators or protected in such a way that the adhesive sheet with the two adhesive faces are wound in a roll shape using one separator both sides of which are release faces. The separator, which is used as a protective material of the pressure-sensitive adhesive layer, is peeled off when the adhesive sheet is laminated to the adherend. If the pressure-sensitive adhesive sheet according to the present invention is a substrateless pressure-sensitive adhesive sheet, the separator also functions as a supporting member for the pressure-sensitive adhesive layer. The separator does not have to be provided.

Any customary release paper or the like may be used as the separator. Examples of the separator include, but are not especially limited to, a substrate having a release-treated layer, a low adhesion substrate formed from a fluoropolymer, and a low adhesion substrate formed from a non-polar polymer. Examples of a substrate having such a release-treated layer include a plastic film or paper whose surface has been treated with a silicone, long-chain alkyl, fluorine, molybdenum sulfide or similar release agent. Examples of the fluoropolymer in the low adhesion substrate formed from a fluoropolymer include polytetrafluoroethylene, polychlorotrifluoroethylene, polyvinyl fluoride, polyvinylidene fluoride, a tetrafluoroethylene-hexafluoropropylene copolymer, and a chlorofluoroethylene-vinylidene fluoride copolymer. Examples of the non-polar polymer include an olefin resin (e.g., polyethylene, polypropylene), a polyester substrate (e.g., a polyethylene terephthalate substrate, a polyethylene naphthalate substrate, and a polybutylene terephthalate substrate). The separator can be formed by using a known or customary method. Further, the thickness and the like of the separator are not especially limited.

### [2-7. Pressure-Sensitive Adhesive Sheet Applications etc.]

Since the pressure-sensitive adhesive sheet according to the present invention has the above-described pressure-sensitive adhesive layer (pressure-sensitive adhesive layer formed from the pressure-sensitive adhesive composition according to the present invention), it has excellent adhesion and an excellent resistance to foaming and release, as well as an excellent stress relaxation property and excellent step conformability. Consequently, the pressure-sensitive adhesive sheet according to the present invention has excellent adhesion reliability, especially adhesion reliability at a high temperature. Further, appearance is excellent.

Consequently, the pressure-sensitive adhesive sheet according to the present invention may be effectively used on an adherend which is likely to foam at an interface at high temperatures. For example, in some cases polymethyl methacrylate resin (PMMA) contains unreacted monomers, and is thus likely to foam at high temperatures due to the extraneous materials. Further, polycarbonate (PC) tends to produce water and an outgas of carbon dioxide at high temperatures. Since the pressure-sensitive adhesive sheet according to the present invention has an excellent resistance to foaming and release, it may also be effectively used on a plastic adherend including such a resin.

Still further, the pressure-sensitive adhesive sheet according to the present invention is effectively used on an adherend having a large coefficient of linear expansion in addition to an adherend having a small coefficient of linear expansion. Examples of such an adherend having a small coefficient of linear expansion include, but are not especially limited to, a glass plate (coefficient of linear expansion: from 0.3×10⁻⁵ to 0.8×10⁻⁵/° C.), and a polyethylene terephthalate substrate (PET film, coefficient of linear expansion: from 1.5×10⁻⁵ to 2×10⁻⁵/° C.). Examples of such an adherend having a large coefficient of linear expansion include, but are not especially limited to, a resin substrate having a large coefficient of linear expansion. More specifically, such examples include a polycarbonate resin substrate (PC, coefficient of linear expansion: from 7×10⁻⁵ to 8×10⁻⁵/° C.), a polymethyl methacrylate resin substrate (PMMA, coefficient of linear expansion: from 7×10⁻⁵ to 8×10⁻⁵/° C.), a cycloolefin polymer substrate (COP, coefficient of linear expansion: from 6×10⁻⁵ to 7×10⁻⁵/° C.), “Zeonor” (trade name, manufactured by Nippon Zeon Co., Ltd.), and “Arton” (trade name, manufactured by JSR).

The pressure-sensitive adhesive sheet according to the present invention is effectively used for bonding an adherend having a small coefficient of linear expansion and an adherend having a large coefficient of linear expansion. Specifically, the pressure-sensitive adhesive sheet according to the present invention may be preferably used for bonding a glass adherend (e.g., a glass plate, chemically-strengthened glass, a glass lens) and the above-described resin substrate having a large coefficient of linear expansion.

Thus, the pressure-sensitive adhesive sheet according to the present invention is effectively used for bonding adherends formed from various materials, especially for bonding a glass adherend and a plastic adherend. The plastic adherend may also be an optical film such as a plastic film having an ITO (oxide of indium and tin) layer on a surface.

Furthermore, the pressure-sensitive adhesive sheet according to the present invention is effectively used on an adherend having a step on the surface thereof in addition to an adherend having a smooth surface. Especially, even when at least one of a glass adherend and the above-described resin substrates having a large coefficient of linear expansion has a step on the surface thereof, the pressure-sensitive adhesive sheet according to the present invention can be effectively used for bonding the glass adherend and the above-described resin substrate having a large coefficient of linear expansion.

The pressure-sensitive adhesive sheet according to the present invention can be preferably used for manufacturing portable electronic devices. Examples of such portable electronic devices include a mobile phone, PHS, a smartphone, a tablet (tablet computer), a mobile computer (mobile PC), a personal digital assistant (PDA), an electronic notebook, a portable broadcast receiver including a portable television receiver and a portable radio receiver, a portable game machine, a portable audio player, a portable DVD player, a camera including a digital camera, and a camcorder video camera.

The pressure-sensitive adhesive sheet according to the present invention can be preferably used for bonding members and modules for constituting a portable electronic device to each other, fixing the member or module to a housing and the like. More specifically, examples thereof include bonding between a cover glass or lens (especially a glass lens) and a touch panel or touch sensor, fixation of a cover glass or lens (especially a glass lens) to a housing, fixation of a display panel to a housing, fixation of an input device, such as a sheet keyboard and a touch panel, to a housing, bonding between a protective panel of an information display part and a housing, bonding housings to each other, bonding between a housing and a decorative sheet, and fixation or bonding of various members or modules for constituting a portable electronic device. The term “display panel” in the present specification means a structure which is configured from at least a lens (especially a glass lens) and a touch panel. In addition, the lens in the present specification is a component including both a transparent body that exhibits a light refracting action and a transparent body not having a light refracting action. The term lens in the present specification also includes a mere window panel not having a light refracting action.

Further, the pressure-sensitive adhesive sheet according to the present invention can be preferably used for an optical application. The pressure-sensitive adhesive sheet according to the present invention is preferably an optical pressure-sensitive adhesive sheet which is used for an optical application. Specifically, the pressure-sensitive adhesive sheet according to the present invention is preferably used for, for example, bonding an optical component (optical component bonding application) and manufacturing a product (optical product) using the above-described optical component.

### [3. Optical Component]

The optical component according to the present invention is not especially limited provided that it includes at least one above-described pressure-sensitive adhesive sheet and a base material, the base material includes metal wiring (e.g., copper wiring) on at least one face, and the above-described pressure-sensitive adhesive layer (pressure-sensitive adhesive layer formed from the pressure-sensitive adhesive composition according to the present invention) is attached onto the face with the metal wiring of the base material. Further, although the above-described pressure-sensitive adhesive sheet may be provided with a separator on the pressure-sensitive adhesive face until usage, the above-described pressure-sensitive adhesive sheet in the optical component according to the present invention is being in use and does not have a separator.

In terms of obtaining an better corrosion inhibition effect, it is preferred that the optical component has the above-described pressure-sensitive adhesive layer on the opposite side to the side of the base material that has the metal wiring. More preferably, the above-described pressure-sensitive adhesive layer is attached onto the face on the opposite side to the side of the base material that has the metal wiring.

Examples of the material for forming the metal wiring include, but are not especially limited to, metals such as titanium, silicon, niobium, indium, zinc, tin, gold, silver, copper, aluminum, cobalt, chromium, nickel, lead, iron, palladium, platinum, tungsten, zirconium, tantalum, and hafnium. Further examples may include a substance containing two or more of these metals, or an alloy having these metals as a main component. Among these examples, in terms of conductivity, gold, silver, and copper are preferred, and in terms of conductivity and cost, copper is more preferred. Specifically, it is especially preferred that the metal wiring is copper wiring. The above description regarding the material for forming the metal wiring is applied to a material for forming a metal wiring in the below-described touch panel.

The term “optical component” refers to a member having an optical property (e.g., a polarization property, a photorefractive property, a light scattering property, a light reflective property, a light transmitting property, a light absorbing property, a light diffractive property, an optical rotation property, visibility). Examples of the base material for constituting the optical component include, but are not especially limited to, a base material for constituting a device (optical device), such as display device (image display device) and an input device, or a base material used in such devices. Examples thereof may include a polarizing plate, a wave plate, a retardation plate, an optical compensation film, a brightness enhancing film, a light guide plate, a reflective film, an anti-reflective film, a hard coat film (a film subjected to a hard coat treatment on at least one side of a plastic film such as a PET film), a transparent conductive film (e.g. plastic film having an ITO layer on the surface thereof (preferably, an ITO film of PET-ITO, polycarbonate, a cycloolefin polymer etc.)), a design film, a decorative film, a surface protective film, a prism, a lens, a color filter, a transparent base material (a glass base material of a glass sensor, a glass display panel (LCD etc.), and a glass plate provided with a transparent electrode etc.), as well as a base material in which these are laminated (these are sometimes collectively referred to as “a functional film”). Further, these films may also have a metal nanowire layer, a conductive polymer layer and the like. Still further, fine metal wiring may be mesh-printed on these films. The terms “plate” and “film” respectively include shapes such as a plate shape, a film shape, and a sheet shape. For example, the term “polarizing film” includes “polarizing plate” and “polarizing sheet”. In addition, the term “film” includes a film sensor.

Examples of the display device include a liquid crystal display device, an organic electroluminescence (EL) display device, a plasma display panel (PDP), and electronic paper. Further, examples of the input device include a touch panel.

Examples of the base material for constituting the optical component include, but are not especially limited to, a base material (e.g., a sheet shape, film shape, or plate shape base material) formed from glass, acrylic resin, polycarbonate, polyethylene terephthalate, a cycloolefin polymer, a metal thin film or the like. As described above, the term “optical component” in the present invention also includes a member (a design film, a decorative film, a surface protective film etc.) for decoration or protection while achieving visibility of the display device or the input device.

If the pressure-sensitive adhesive sheet according to the present invention is a pressure-sensitive adhesive sheet with a substrate and configures a member having optical properties, the substrate can be viewed as being the above-described base material, so that the pressure-sensitive adhesive sheet can be said to also be the optical component according to the present invention.

If the pressure-sensitive adhesive sheet according to the present invention is a pressure-sensitive adhesive sheet with a substrate and the above-described functional film is used as the substrate, the pressure-sensitive adhesive sheet according to the present invention can also be used as a “pressure-sensitive adhesive functional film” having the pressure-sensitive adhesive layer on at least one side of the functional film.

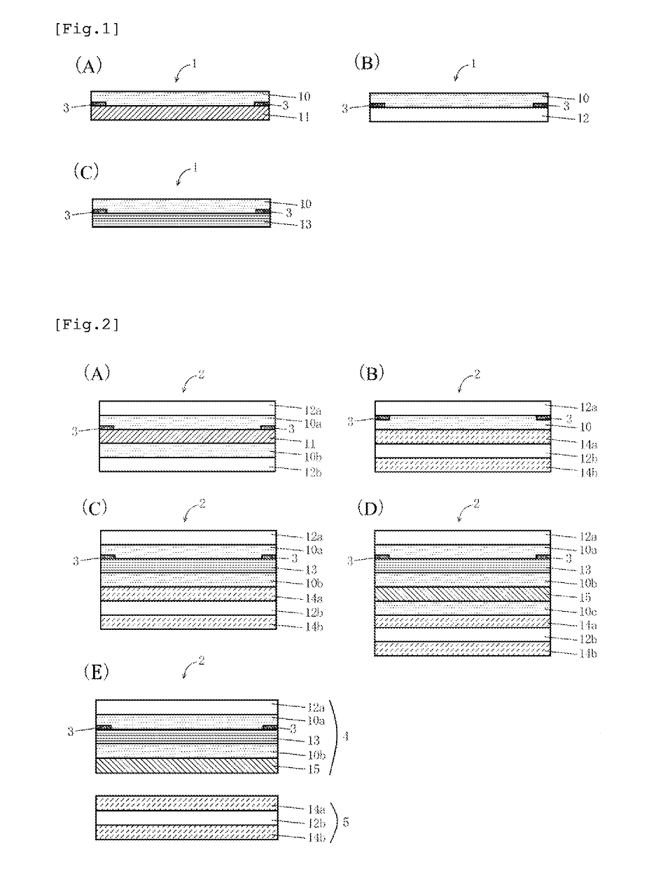

Next, specific examples of especially preferred embodiments of the optical component according to the present invention will be described with reference to the schematic diagrams of FIG. 1.

FIG. 1(A) illustrates an optical component 1 including, at least, a pressure-sensitive adhesive sheet 10 and a transparent conductive film 11 as a base material. The transparent conductive film 11 includes a pattern of metal wiring 3 on its one face. The pressure-sensitive adhesive sheet 10 is attached onto the face on the metal wiring 3 side of the transparent conductive film 11.

FIG. 1(B) illustrates an optical component 1 including, at least, a pressure-sensitive adhesive sheet 10 and a transparent substrate 12 as a base material. The transparent substrate 12 includes a pattern of metal wiring 3 on its one face. The pressure-sensitive adhesive sheet 10 is attached onto the face on the metal wiring 3 side of the transparent substrate 12.

FIG. 1(C) illustrates an optical component 1 including, at least, a pressure-sensitive adhesive sheet 10 and a film sensor 13 as a base material. The film sensor 13 includes a pattern of metal wiring 3 on its one face. The pressure-sensitive adhesive sheet 10 is attached onto the face on the metal wiring 3 side of the film sensor 13.

### [4. Touch Panel]

The touch panel according to the present invention is not especially limited provided that it has, at least, the above-described pressure-sensitive adhesive sheet and a base material, the base material includes a pattern of metal wiring (e.g., copper wiring) on its one face, and the above-described pressure-sensitive adhesive sheet is attached onto the face on the metal wiring side of the base material. The above-described pressure-sensitive adhesive sheet in the touch panel according to the present invention is being in use and does not have a separator.

A preferred embodiment of the touch panel has a configuration in which the optical component according to the present invention is bonded to one or more other optical components which preferably include the above-described pressure-sensitive adhesive sheet in terms of the fact that a corrosion inhibition effect is obtained. One other optical component or a plurality of other optical components may be provided.

Examples of the above-described configuration may include, but are not especially limited to, (1) bonding the optical component according to the present invention and the other optical component via the pressure-sensitive adhesive sheet according to the present invention, (2) bonding the pressure-sensitive adhesive sheet according to the present invention that includes or constitutes an optical component and the other optical component, (3) bonding an optical component and a member other than an optical component via the pressure-sensitive adhesive sheet according to the present invention, and (4) bonding the pressure-sensitive adhesive sheet according to the present invention that includes or constitutes an optical component and a member other than an optical component. In the above embodiment (2), it is preferred that the pressure-sensitive adhesive sheet according to the present invention is a double-sided pressure-sensitive adhesive sheet which has a substrate as an optical component (e.g., an optical film).

Next, specific examples of especially preferred embodiments of the touch panel according to the present invention will be described with reference to the schematic diagrams of FIG. 2.

FIG. 2(A) illustrates a touch panel 2 including, in a predetermined laminated structure, a transparent substrate 12a, a pressure-sensitive adhesive sheet 10a according to the present invention, a transparent conductive film 11, a pressure-sensitive adhesive sheet 10b, and a transparent substrate 12b. The transparent conductive film 11 includes a pattern of metal wiring 3 on the face on the pressure-sensitive adhesive sheet 10a side. The pressure-sensitive adhesive sheet 10a is attached onto the face on the metal wiring 3 side of the transparent conductive film 11. It is preferred that the transparent substrates 12a and 12b are made of glass, and that the transparent conductive film 11 is a PET-ITO film. Although the pressure-sensitive adhesive sheet 10b does not have to be the pressure-sensitive adhesive sheet according to the present invention, it is preferred that it is the pressure-sensitive adhesive sheet according to the present invention.

FIG. 2(B) illustrates a touch panel 2 including, in a predetermined laminated structure, a transparent substrate 12a, a pressure-sensitive adhesive sheet 10 according to the present invention, a polarizing plate 14a, a transparent substrate 12b, and a polarizing plate 14b. The transparent substrate 12a includes a pattern of metal wiring 3 on the face on the pressure-sensitive adhesive sheet 10 side. The pressure-sensitive adhesive sheet 10 is attached onto the face on the metal wiring 3 side of the transparent substrate 12a. It is preferred that the transparent substrate 12a is a cover glass sensor, and that the transparent substrate 12b is, for example, a glass display panel, such as an LCD.

FIG. 2(C) illustrates a touch panel 2 including, in a predetermined laminated structure, a transparent substrate 12a, a pressure-sensitive adhesive sheet 10a according to the present invention, a film sensor 13, a pressure-sensitive adhesive sheet 10b, a polarizing plate 14a, a transparent substrate 12b, and a polarizing plate 14b. The film sensor 13 includes a pattern of metal wiring 3 on the face on the pressure-sensitive adhesive sheet 10a side. The pressure-sensitive adhesive sheet 10a is attached onto the face on the metal wiring 3 side of the film sensor 13. It is preferred that the transparent substrate 12a is made of glass, and that the transparent substrate 12b is, for example, a glass display panel, such as an LCD. Although the pressure-sensitive adhesive sheet 10b does not have to be configured from the above-described pressure-sensitive adhesive layer (pressure-sensitive adhesive layer formed from the pressure-sensitive adhesive composition according to the present invention), it is preferred that it is configured from the above-described pressure-sensitive adhesive layer (pressure-sensitive adhesive layer formed from the pressure-sensitive adhesive composition according to the present invention).

FIG. 2(D) illustrates a touch panel 2 including, in a predetermined laminated structure, a transparent substrate 12a, a pressure-sensitive adhesive sheet 10a according to the present invention, a film sensor 13, a pressure-sensitive adhesive sheet 10b, a hard coat film 15, a pressure-sensitive adhesive sheet 10c, a polarizing plate 14a, a transparent substrate 12b, and a polarizing plate 14b. The film sensor 13 includes a pattern of metal wiring 3 on the face on the pressure-sensitive adhesive sheet 10a side. The pressure-sensitive adhesive sheet 10a is attached onto the face on the metal wiring 3 side of the film sensor 13. It is preferred that the transparent substrate 12a is made of glass, that the transparent substrate 12b is, for example, a glass display panel, such as an LCD, and that the hard coat film 15 is a hard coat PET film. Although the pressure-sensitive adhesive sheets 10b and 10c do not have to be configured from the above-described pressure-sensitive adhesive layer (pressure-sensitive adhesive layer formed from the pressure-sensitive adhesive composition according to the present invention), it is preferred that they are configured from the above-described pressure-sensitive adhesive layer (pressure-sensitive adhesive layer formed from the pressure-sensitive adhesive composition according to the present invention).

FIG. 2(E) illustrates a touch panel 2 including an optical component 4 and an optical component 5. The optical component 4 includes, in a predetermined laminated structure, a transparent substrate 12a, a pressure-sensitive adhesive sheet 10a according to the present invention, a film sensor 13, a pressure-sensitive adhesive sheet 10b, and a hard coat film 15. The optical component 5 includes, in a predetermined laminated structure, a polarizing plate 14a, a transparent substrate 12b, and a polarizing plate 14b. The optical components 4 and 5 are positioned so that the hard coat film 15 and the polarizing plate 14a are facing each other. The hard coat film 15 is not in contact with the polarizing plate 14a. An air layer is formed between the hard coat film 15 and the polarizing plate 14a. The film sensor 13 includes a pattern of metal wiring 3 on the face on the pressure-sensitive adhesive sheet 10a side. The pressure-sensitive adhesive sheet 10a is attached onto the face on the metal wiring 3 side of the film sensor 13. It is preferred that the transparent substrate 12a is made of glass, that the transparent substrate 12b is, for example, a glass display panel, such as an LCD, and that the hard coat film 15 is a hard coat PET film. Although the pressure-sensitive adhesive sheets 10b does not have to be configured from the above-described pressure-sensitive adhesive layer (pressure-sensitive adhesive layer formed from the pressure-sensitive adhesive composition according to the present invention), it is preferred that it is configured from the pressure-sensitive adhesive layer (pressure-sensitive adhesive layer formed from the pressure-sensitive adhesive composition according to the present invention).

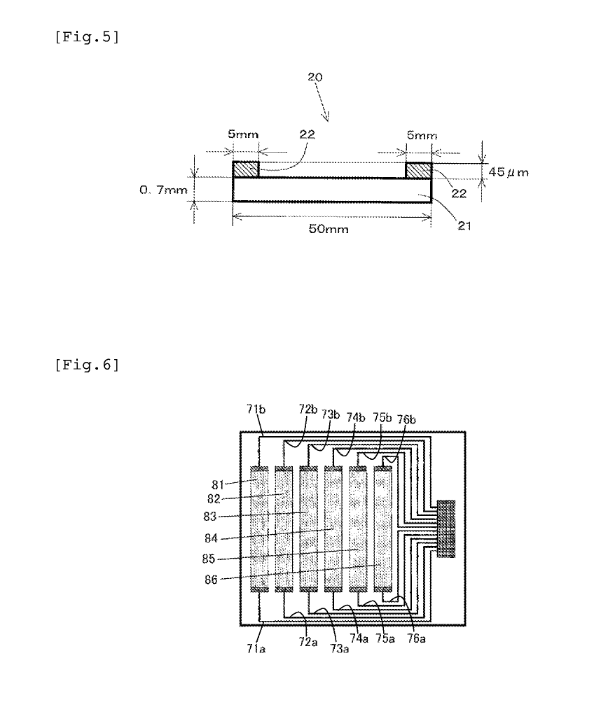

Further, examples of the metal wiring pattern (wiring example of the metal wiring) include, but are not especially limited to, the metal wiring pattern illustrated in FIG. 6. FIG. 6 is a schematic plan view illustrating an example of a metal wiring pattern. In FIG. 6, reference characters 71a to 76a each denotes metal wiring (pattern wiring), reference characters 71b to 76b each denotes metal wiring (pattern wiring), and reference numerals 81 to 86 each denotes an electrode (transparent electrode). Each electrode is connected to the corresponding metal wiring. For example, the electrode 81 is connected to metal wiring 71a and metal wiring 71b. In addition, in FIG. 6, although the electrodes are each patterned in a strip shape, the shape of each electrode is not limited to a strip shape. Moreover, in FIG. 6, although each electrode is connected to the metal wiring at two points, the number of connection points of the metal wiring in the electrode is not especially limited. For example, the electrode may be connected to the metal wiring at one point, or connected to the metal wiring at three or more points. Further, the metal wiring may be connected as necessary to a control means, such as an IC.

Examples of the method for forming the above-described metal wiring pattern include, but are not especially limited to, a method that uses etching or the like to partially remove a metal layer provided in advance, and a printing method.

### EXAMPLES

The present invention will now be described in more detail with reference to the following examples. However, the present invention is not in any way limited to the following examples.

### Acrylic Polymer Production Example 1

A four-necked flask was charged with 60 parts by weight of dicyclopentanyl methacrylate (DCPMA, dicyclopentanyl methacrylate), 40 parts by weight of methyl methacrylate (MMA), 3.5 parts by weight of α-thioglycerol as a chain transfer agent, and 100 parts by weight of toluene as a polymerization solvent, and the contents were stirred at 70° C. for one hour under a nitrogen atmosphere. Next, 0.2 parts by weight of 2,2′-azobisisobutyronitrile as a polymerization initiator was charged into the four-necked flask, and the contents were reacted at 70° C. for 2 hours, and then at 80° C. for 2 hours. The reaction solution was then placed in an atmosphere having a temperature of 130° C. to dry and remove the toluene, the chain transfer agent, and the unreacted monomers, thereby obtaining a solid acrylic polymer. The obtained acrylic polymer was designated as “acrylic polymer (B-1)”.

The acrylic polymer (B-1) had a weight average molecular weight (Mw) of 5.1×10³.

### Example 1

A monomer mixture formed from 68 parts by weight of 2-ethylhexyl acrylate (2EHA), 14.5 parts by weight of N-vinyl-2-pyrrolidone (NVP), and 17.5 parts by weight of 2-hydroxyethyl acrylate (HEA) was blended with 0.035 parts by weight of a photopolymerization initiator (trade name: “Irgacure 184”, manufactured by BASF SE) and 0.035 parts by weight of a photopolymerization initiator (trade name: “Irgacure 651”, manufactured by BASF SE). The resultant mixture was then irradiated with UV-rays until the viscosity (measured using a BH viscometer equipped with a No. 5 rotor at 10 rpm, at a measuring temperature of 30° C.) reached about 20 Pa·s, thereby obtaining a prepolymer composition in which a part of the above-described monomer components had been polymerized.

Next, 100 parts by weight of this prepolymer composition was charged with 5 parts by weight of the above acrylic polymer (B-1), 0.075 parts by weight of hexanediol diacrylate (HDDA), 0.3 parts by weight of a silane coupling agent (trade name: “KBM-403”, manufactured by Shin-Etsu Chemical Co., Ltd.), and 0.05 parts by weight of 1,2,3-benzotriazole (trade name: “BT-120”, manufactured by Johoku Chemical Co., Ltd.). The contents were mixed to obtain a pressure-sensitive adhesive composition (pre-cured composition).

The above pressure-sensitive adhesive composition was coated on a polyethylene terephthalate (PET) separator (trade name: “MRF50”, manufactured by Mitsubishi Plastics, Inc.) such that a final thickness (thickness of the pressure-sensitive adhesive layer) was 100 μm, thereby forming a coating layer (pressure-sensitive adhesive composition layer). Next, on this coating layer, a PET separator (trade name: “MRF38”, manufactured by Mitsubishi Plastics, Inc.) was provided to cover the coating layer and block oxygen, whereby an MRF50/coating layer (pressure-sensitive adhesive composition layer)/MRF38 laminate was obtained.

Next, this laminate was irradiated for 300 seconds with UV-rays at an illuminance of 5 mW/cm² from the upper face (MRF38 side) of the laminate by a black light (manufactured by Toshiba Corporation). Further, a drying treatment was carried out for 2 minutes in a dryer at 90° C. to evaporate the residual monomers. Then, a substrateless double-sided pressure-sensitive adhesive sheet formed from only the pressure-sensitive adhesive layer, in which both faces of the pressure-sensitive adhesive layer were protected by a separator, was obtained.

### Example 2

A substrateless double-sided pressure-sensitive adhesive sheet was obtained in the same manner as in Example 1, except that the amount of 1,2,3-benzotriazole used was changed to 0.1 parts by weight.

### Example 3

A substrateless double-sided pressure-sensitive adhesive sheet was obtained in the same manner as in Example 1, except that the amount of 1,2,3-benzotriazole used was changed to 0.2 parts by weight.

### Example 4

A substrateless double-sided pressure-sensitive adhesive sheet was obtained in the same manner as in Example 1, except that the amount of 1,2,3-benzotriazole used was changed to 0.3 parts by weight and the thickness of the pressure-sensitive adhesive layer was changed to 50 μm.

### Example 5

A substrateless double-sided pressure-sensitive adhesive sheet was obtained in the same manner as in Example 1, except that the amount of 1,2,3-benzotriazole used was changed to 0.3 parts by weight.

### Example 6

A substrateless double-sided pressure-sensitive adhesive sheet was obtained in the same manner as in Example 1, except that the amount of 1,2,3-benzotriazole used was changed to 0.3 parts by weight and the thickness of the pressure-sensitive adhesive layer was changed to 150 μm.

### Example 7

A substrateless double-sided pressure-sensitive adhesive sheet was obtained in the same manner as in Example 1, except that the amount of 1,2,3-benzotriazole used was changed to 0.3 parts by weight and the thickness of the pressure-sensitive adhesive layer was changed to 250 μm.

### Example 8

A substrateless double-sided pressure-sensitive adhesive sheet was obtained in the same manner as in Example 1, except that the amount of 1,2,3-benzotriazole used was changed to 0.5 parts by weight.

### Example 9

A substrateless double-sided pressure-sensitive adhesive sheet was obtained in the same manner as in Example 1, except that the amount of 1,2,3-benzotriazole used was changed to 2.0 parts by weight.

### Example 10

A substrateless double-sided pressure-sensitive adhesive sheet was obtained in the same manner as in Example 1, except that 0.5 parts by weight of 5-methylbenzotriazole (trade name: “5M-BTA”, manufactured by Johoku Chemical Co., Ltd.) was used instead of the 1,2,3-benzotriazole.

### Example 11

A substrateless double-sided pressure-sensitive adhesive sheet was obtained in the same manner as in Example 1, except that 0.5 parts by weight of 1-[N,N-bis(2-ethylhexyl)aminomethyl]benzotriazole (trade name: “BT-LX”, manufactured by Johoku Chemical Co., Ltd.) was used instead of the 1,2,3-benzotriazole.

### Example 12

A substrateless double-sided pressure-sensitive adhesive sheet was obtained in the same manner as in Example 1, except that 0.5 parts by weight of 1-[N,N-bis(2-ethylhexyl)aminomethyl]methylbenzotriazole (trade name: “TT-LX”, manufactured by Johoku Chemical Co., Ltd.) was used instead of the 1,2,3-benzotriazole.

### Example 13

A substrateless double-sided pressure-sensitive adhesive sheet was obtained in the same manner as in Example 1, except that the amount of 1,2,3-benzotriazole used was changed to 0.3 parts by weight, the composition of the above-described monomer mixture was changed to 60 parts by weight of lauryl acrylate (LA), 22 parts by weight of 2-ethylhexyl acrylate (2EHA), 10 parts by weight of N-vinyl-2-pyrrolidone (NVP), and 8 parts by weight of 4-hydroxybutyl acrylate (4HBA), and 0.035 parts by weight of dipentaerythritol hexaacrylate (DPHA) was used instead of the 0.075 parts by weight of hexanediol diacrylate (HDDA).

### Example 14

A substrateless double-sided pressure-sensitive adhesive sheet was obtained in the same manner as in Example 1, except that the amount of 1,2,3-benzotriazole used was changed to 0.3 parts by weight, the composition of the above-described monomer mixture was changed to 61 parts by weight of 2-ethylhexyl acrylate (2EHA), 14 parts by weight of N-vinyl-2-pyrrolidone (NVP), and 25 parts by weight of 4-hydroxybutyl acrylate (4HBA), and the amount of hexanediol diacrylate (HDDA) was changed to 0.060 parts by weight.

### Example 15

A substrateless double-sided pressure-sensitive adhesive sheet was obtained in the same manner as in Example 1, except that the amount of 1,2,3-benzotriazole used was changed to 5.0 parts by weight.

### Example 16

A substrateless double-sided pressure-sensitive adhesive sheet was obtained in the same manner as in Example 1, except that the amount of 1,2,3-benzotriazole used was changed to 0.5 parts by weight, the acrylic polymer (B-1) was not used, and the composition of the above-described monomer mixture was changed to 78 parts by weight of 2-ethylhexyl acrylate (2EHA), 18 parts by weight of N-vinyl-2-pyrrolidone (NVP), and 4 parts by weight of 2-hydroxyethyl acrylate (HEA).

### Example 17

A prepolymer composition was obtained in the same manner as in Example 1, except that a monomer mixture formed from 85 parts by weight of 2-ethylhexyl acrylate (2EHA), 5 parts by weight of isobornyl acrylate (IBXA), and 5 parts by weight of N-vinyl-2-pyrrolidone (NVP) was used.

Next, 100 parts by weight of this prepolymer composition was charged with 0.080 parts by weight of hexanediol diacrylate (HDDA), 0.3 parts by weight of a silane coupling agent (trade name: “KBM-403”, manufactured by Shin-Etsu Chemical Co., Ltd.), and 0.5 parts by weight of 1,2,3-benzotriazole (trade name: “BT-120”, manufactured by Johoku Chemical Co., Ltd.). The contents were mixed to obtain a pressure-sensitive adhesive composition (pre-cured composition).

Then, a substrateless double-sided pressure-sensitive adhesive sheet was obtained in the same manner as in Example 1, using the above-described pressure-sensitive adhesive composition.

### Comparative Example 1

A substrateless double-sided pressure-sensitive adhesive sheet was obtained in the same manner as in Example 1, except that 1,2,3-benzotriazole was not used.

### Comparative Example 2

A substrateless double-sided pressure-sensitive adhesive sheet was obtained in the same manner as in Example 1, except that 0.5 parts by weight of pentaerythritol tetrakis[3-(3,5-di-tert-butyl-4-hydroxyphenyl)propionate] (trade name: “Irganox 1010”, manufactured by BASF SE) was used instead of the 1,2,3-benzotriazole.

### Comparative Example 3

A substrateless double-sided pressure-sensitive adhesive sheet was obtained in the same manner as in Example 1, except that 1,2,3-benzotriazole was not used, the acrylic polymer (B-1) was not used, the composition of the above-described monomer mixture was changed to 90 parts by weight of 2-ethylhexyl acrylate (2EHA) and 10 parts by weight of acrylic acid (AA), and 0.070 parts by weight of dipentaerythritol hexaacrylate (DPHA) was used instead of the 0.075 parts by weight of hexanediol diacrylate (HDDA).

### Comparative Example 4

A substrateless double-sided pressure-sensitive adhesive sheet was obtained in the same manner as in Example 1, except that the amount of 1,2,3-benzotriazole used was changed to 0.5 parts by weight, the acrylic polymer (B-1) was not used, the composition of the above-described monomer mixture was changed to 90 parts by weight of 2-ethylhexyl acrylate (2EHA) and 10 parts by weight of acrylic acid (AA), and 0.070 parts by weight of dipentaerythritol hexaacrylate (DPHA) was used instead of the 0.075 parts by weight of hexanediol diacrylate (HDDA).

### Comparative Example 5

A separable flask was charged with 63 parts by weight of 2-ethylhexyl acrylate (2EHA), 15 parts by weight of N-vinyl-2-pyrrolidone (NVP), 9 parts by weight of methyl methacrylate (MMA), and 13 parts by weight of 2-hydroxyethyl acrylate (HEA) as monomer components, as well as 150 parts by weight of ethyl acetate as a polymerization solvent, and the contents were stirred for one hour while introducing nitrogen gas. After removing oxygen in the polymerization system in this way, the contents were heated to 63° C. and charged with 0.2 parts by weight of 2,2′-azobisisobutyronitrile as a polymerization initiator. The contents were reacted for 10 hours, thereby obtaining an acrylic polymer solution having a solid concentration of 35 wt. %.

The above acrylic polymer solution was charged with 1.1 parts by weight of a cross-linking agent (a xylylene diisocyanate/trimethylolpropane adduct, trade name: “Takenate D110N”, manufactured by Mitsui Chemicals Co., Ltd.), 0.15 parts by weight of a silane coupling agent (trade name: “KBM-403”, manufactured by Shin-Etsu Chemical Co., Ltd.), and 0.3 parts by weight of 1,2,3-benzotriazole (trade name: “BT-120”, manufactured by Johoku Chemical Co., Ltd.). The contents were mixed to obtain a solvent type pressure-sensitive adhesive composition (pre-cured composition).

Then, the above pressure-sensitive adhesive composition was coated on a polyethylene terephthalate (PET) separator (trade name: “MRF50”, manufactured by Mitsubishi Plastics, Inc.) such that a final thickness (thickness of the pressure-sensitive adhesive layer) was 100 μm, thereby forming a coating layer (pressure-sensitive adhesive composition layer). Then, the coating layer was dried by heating under a 110° C. environment for 3 minutes to obtain an MRF50/pressure-sensitive adhesive layer laminate.

Next, on the above pressure-sensitive adhesive layer, a PET separator (trade name: “MRF38”, manufactured by Mitsubishi Plastics, Inc.) was provided to cover the pressure-sensitive adhesive layer. Then, a substrateless double-sided pressure-sensitive adhesive sheet formed from only the pressure-sensitive adhesive layer, in which both faces of the pressure-sensitive adhesive layer were protected by a separator, was obtained.

### Comparative Example 6

One hundred parts by weight of 2-ethylhexyl acrylate (2EHA) was blended with 0.035 parts by weight of a photopolymerization initiator (trade name: “Irgacure 184”, manufactured by BASF SE) and 0.035 parts by weight of a photopolymerization initiator (trade name: “Irgacure 651”, manufactured by BASF SE). The resultant mixture was then irradiated with UV-rays until the viscosity (measured using a BH viscometer equipped with a No. 5 rotor at 10 rpm, at a measuring temperature of 30° C.) reached about 20 Pa·s, thereby obtaining a prepolymer composition in which a part of the above-described monomer component had been polymerized.

Next, 100 parts by weight of this prepolymer composition was charged with 0.075 parts by weight of hexanediol diacrylate (HDDA), 0.3 parts by weight of a silane coupling agent (trade name: “KBM-403”, manufactured by Shin-Etsu Chemical Co., Ltd.), and 2 parts by weight of 1,2,3-benzotriazole (trade name: “BT-120”, manufactured by Johoku Chemical Co., Ltd.), and the contents were mixed.

However, 1,2,3-benzotriazole did not dissolve, and a pressure-sensitive adhesive composition was not able to be obtained.

### [Properties Evaluation]

The substrateless double-sided pressure-sensitive adhesive sheets of the examples and the comparative examples were subjected to the following measurements and evaluations. The results are shown in Table 2.

### (1) Metal Corrosion

### [Rate of Change in Sheet Resistivity]

A double-sided pressure-sensitive adhesive sheet was, after peeling of one of its separators, pressure-bonded and laminated onto a film, in which a copper layer had been provided on one face of a cycloolefin (COP) substrate (trade name: “Zeonor”, manufactured by Nippon Zeon Corporation, thickness: 100 μm), hereinafter sometimes referred to as “copper film”, on the substrate face side of the film by moving a 2-kg roller back and forth once to obtain a structure A having a laminated structure of the copper film and the double-sided pressure-sensitive adhesive sheet.

Next, the structure A was cut to a 15 mm×15 mm size, the other separator of the double-sided pressure-sensitive adhesive sheet was peeled off, and the structure A was then pressure-bonded and laminated onto a soda glass plate (25 mm×25 mm, thickness 0.7 mm) by moving a 2-kg roller back and forth once to obtain a structure B having a laminated structure of the copper film, the double-sided pressure-sensitive adhesive sheet, and the glass plate.

Separately, a double-sided pressure-sensitive adhesive sheet identical with that in the structure B was, after peeling of one of its separators, pressure-bonded and laminated onto a film, in which an antireflection treatment layer had been provided on one face of a triacetyl cellulose (TAC) substrate (trade name: “DSC-03”, manufactured by Dai Nippon Printing Co., Ltd., thickness: 90 μm, hereinafter sometimes referred to as “AR film”), on the substrate face side of the film by moving a 2-kg roller back and forth once to obtain a structure C having a laminated structure of the AR film and the double-sided pressure-sensitive adhesive sheet. Next, the structure C was cut to a 10 mm×10 mm size, the other separator of the double-sided pressure-sensitive adhesive sheet was peeled off, and the structure C was pressure-bonded and laminated onto the center portion on the copper face side of the structure B by moving a 2-kg roller back and forth once to obtain a structure D having a five-layer laminated structure of the AR film, the double-sided pressure-sensitive adhesive sheet, the copper film, the double-sided pressure-sensitive adhesive sheet, and the glass plate.

The structure D was left for 30 minutes under a 23° C., 50% RH atmosphere, then placed in an autoclave, and subjected to an autoclave treatment for 15 minutes under a temperature of 50° C. and a pressure of 0.5 MPa. The treated structure D was removed from the autoclave, and then left for 24 hours under a 23° C., 50% RH (RH: relative humidity) atmosphere.

As the apparatus for measuring the sheet resistance value of the copper layer in the structure D, a Hall effect measurement apparatus (trade name: “HL 5500PC”, manufactured by Toho Technology Corporation) was used. Each sheet resistance value (initial sheet resistance: R₀) of the structure D was measured under a 23° C., 50% RH atmosphere.

After measurement, an exposed surface of the copper layer in the structure D was covered to prevent oxidation of such surface of the copper layer, the surface on which the AR film was not laminated via the adhesive sheet, the surface to which the measurement probes can contact. Then the structure D was placed for 300 hours under a 85° C., 85° RH environment. After being removed out from that environment, the structure D was subjected to temperature-and-humidity adjustment for 24 hours under a 23° C., 50% RH environment. The change in the color of the copper from the initial stage was visually confirmed, and then the sheet resistance value (after-testing sheet resistance: R₁) was measured under a 23° C., 50% RH atmosphere.

The rate of change T in the sheet resistance value was determined based on the following calculation formula from the initial sheet resistance value (R₀) and the after-testing sheet resistance value (R₁) measured after having been placed for 300 hours under a 85° C., 85° RH environment.

Rate of change T (%)=(R₁−R₀)/R₀×100

If the rate of change T in the sheet resistance value was less than 150%, the sheet was evaluated as a pass “∘” and as having a good corrosion inhibition performance. On the other hand, if the rate of change T in the sheet resistance value from the initial stage was not less than 150%, the sheet was evaluated as a fail “×” and as not having a good corrosion inhibition performance.

### (2) Total Light Transmittance and Haze

One of the separators was peeled from a double-sided pressure-sensitive adhesive sheet, and this double-sided pressure-sensitive adhesive sheet was laminated on a slide glass (manufactured by Matsunami Glass Ind. Ltd., “White Polish No. 1”, thickness 0.8 to 1.0 mm, total light transmittance 92%, and haze 0.2%). Then, the other separator was peeled off to produce a test piece having a double-sided pressure-sensitive adhesive sheet (pressure-sensitive adhesive layer)/slide glass layer structure.

The total light transmittance and the haze in the visible light region of the above test piece were measured using a haze meter (apparatus name: “HM-150”, manufactured by Murakami Color Research Laboratory Co., Ltd.).

### (3) 180° Peel Adhesion Strength (180° Peel Adhesion Strength to a Glass Plate)

A sheet piece having a length of 100 mm and a width of 20 mm was cut out from a double-sided pressure-sensitive adhesive sheet. Next, one of the separators was peeled off from the sheet piece, and the resulting sheet piece was laminated to (backed with) a PET film (trade name: “Lumirror S-10”, thickness: 25 μm, manufactured by Toray Industries, Inc.). Then, the other separator was peeled off, and the resulting laminate was pressure-bonded to a test plate by moving a 2-kg roller back and forth once and then aged under a 23° C., 50% RH atmosphere for 30 minutes. After the aging, the 180° peel adhesion strength (N/20 mm) of the pressure-sensitive adhesive sheet was measured, based on JIS 20237, using a tensile tester (apparatus name: “Autograph AG-IS”, manufactured by Shimadzu Corporation) in a manner such that the pressure-sensitive adhesive sheet was peeled off from the test plate under a 23° C., 50% RH atmosphere at a peeling speed of 300 mm/min and a peeling angle of 180°.

As the test plate, a glass plate (trade name: “Soda Lime Glass #0050”, manufactured by Matsunami Glass Ind. Ltd.) was used.

### (4) Humid Cloudiness Resistance

A double-sided pressure-sensitive adhesive sheet was cut to a size having a width of 45 mm and a length of 90 mm, one of the separators was then peeled off, and the double-sided pressure-sensitive adhesive sheet was pressure-bonded and laminated onto a soda glass plate (manufactured by Matsunami Glass Ind. Ltd., 100 mm×50 mm, thickness 0.7 mm) by moving a 2-kg roller back and forth once. Next, the other separator was peeled off the above-described laminated double-sided pressure-sensitive adhesive sheet, and a glass plate the same as that described above was laminated thereon with a vacuum lamination apparatus at a surface pressure of 0.2 MPa, a degree of vacuum of 30 Pa, and a lamination time of 10 seconds, to obtain an evaluation sample having a glass plate/double-sided pressure-sensitive adhesive sheet/glass plate structure.

Next, the evaluation sample was placed in an autoclave, and subjected to an autoclave treatment for 15 minutes under a temperature of 50° C. and a pressure of 0.5 MPa. The treated evaluation sample was then removed from the autoclave, and left for 24 hours under a 23° C., 50% RH (RH: relative humidity) atmosphere.

The evaluation sample was placed under a 60° C., 95% RH high-temperature, high-humidity environment for 300 hours. Then, the evaluation sample was removed from that environment, and left for 24 hours under a 23° C., 50% RH environment. The appearance of the evaluation sample was then visually observed to evaluate humid cloudiness resistance based on the following evaluation criteria.

### Evaluation Criteria

A: No whitening
B: Whitening seen only at the four corners of the double-sided pressure-sensitive adhesive sheet
C: Whitening seen on over the whole area of the double-sided pressure-sensitive adhesive sheet

### (5) Resistance to Foaming and Release

A double-sided pressure-sensitive adhesive sheet was, after peeling of one of its separators, pressure-bonded and laminated onto a film, in which an ITO (oxide of indium and tin) layer had been provided on one face of a cycloolefin (COP) substrate (trade name: “Zeonor”, manufactured by Nippon Zeon Corporation, thickness: 100 rim), hereinafter sometimes referred to as “COP-ITO film”, on the ITO layer side of the film by moving a 2-kg roller back and forth once to obtain a structure A′ having a laminated structure of the COP-ITO film and the double-sided pressure-sensitive adhesive sheet.

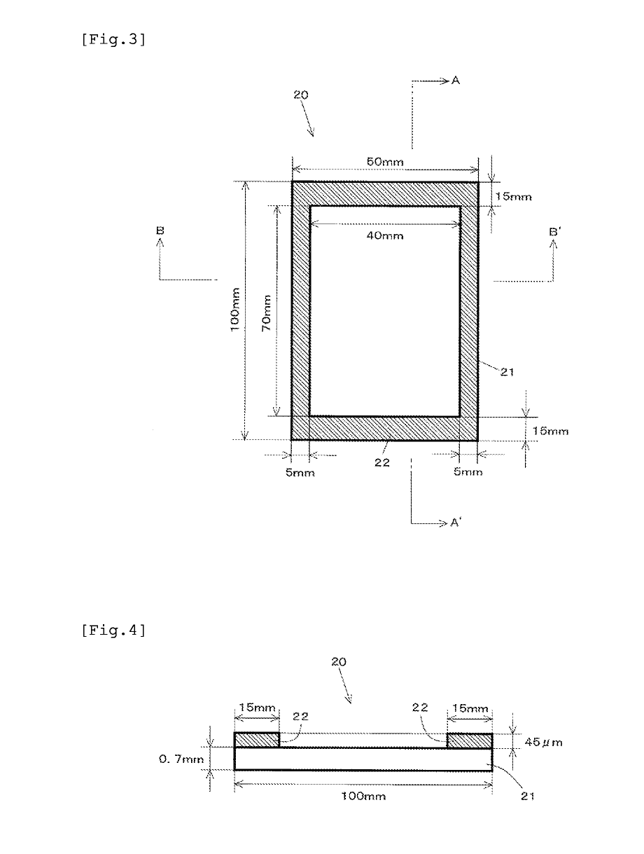

Next, the other separator of the double-sided pressure-sensitive adhesive sheet in the structure A′ was peeled off, and the structure A′ was pressure-bonded and laminated onto the face of a glass with a step (see FIGS. 3 to 5), on the side where the step was present, by moving a 2-kg roller back and forth once to obtain a structure B′ having a laminated structure of the COP-ITO film, the double-sided pressure-sensitive adhesive sheet, and the glass plate with the step.

The structure B′ was left for 1 hour under a 23° C., 50% RH atmosphere, then placed in an autoclave, and subjected to an autoclave treatment for 15 minutes under a temperature of 50° C. and a pressure of 0.5 MPa. The treated structure B′ was then removed from the autoclave, placed into a dryer set up at 85° C., and left for 24 hours.

The structure B′ was then removed from the dryer and left for 30 minutes under a 23° C., 50% RH atmosphere. The presence of foaming (foaming including bubbles caused by extraneous materials) and peeling in the structure B′ was observed with a microscope. The structure B′ was then evaluated based on the following evaluation criteria.

### Evaluation Criteria

A: No foaming or peeling at all
B: Foaming caused by only extraneous materials having a size of not less than 100 μm observed
C: Foaming caused by extraneous materials having a size of less than 100 μm observed
D: Foaming and peeling observed regardless of the presence of extraneous materials

The evaluation of the resistance to foaming and release performed in the above (5) was also carried out on a film in which an ITO (oxide of indium and tin) layer had been provided on one face of a polyethylene terephthalate (PET) substrate (thickness: 50 μm), hereinafter sometimes referred to as “PET-ITO film”, instead of the COP-ITO film.

### (6) Appearance Properties

The double-sided pressure-sensitive adhesive sheets were visually observed and evaluated based on the following evaluation criteria.

### Evaluation Criteria

Good (∘): Occurrence of appearance defects, such as orange peel, is not observed, and the surface is smooth.

Poor (×): Occurrence of appearance defects, such as orange peel, is observed. Note that a sheet on which orange peel has occurred was especially evaluated as “× (orange peel)”.

TABLE 2

| | | | | Metal Corrosion | | | | | Adhe- | | | | |
|---|---|---|---|---|---|---|---|---|---|---|---|---|---|
| | | | | Rate | | | | | sive | | Resistance | | |
| | | | | of | | | | | Force | | to | | |
| | | | | Change | | | Total | | With | Hu | Foaming | | |
| | | | | in | | De- | Light | | Respect | mid | and | | Ap- |
| | | | | Sheet | | ter- | Trans- | | to | Cloud- | Release | | pear- |
| | | | Thick- | Resis- | | mi- | mit- | Ha- | Glass | iness | COP | PET | ance- |
| | | Special | ness | tivity | Visual | na- | tance | ze | [N/20 | Resis- | Sub- | Sub- | Prop- |
| | | Instruction | [μ] | [%] | Observation | tion | [%] | [%] | mm] | tance | strate | strate | erties |
| Work- | 1 | BT-120 0.05 | 100 | 126 | No | ∘ | 92.2 | 0.5 | 17 | A | A | A | ∘ |
| ing | | parts by weight | | | discoloration | | | | | | | | |
| Ex- | 2 | BT-120 0.1 parts | 100 | 123 | No | ∘ | 92.2 | 0.5 | 17 | A | A | A | ∘ |
| am- | | by weight | | | discoloration | | | | | | | | |
| ple | 3 | BT-120 0.2 parts | 100 | 125 | No | ∘ | 92.2 | 0.5 | 18 | A | A | A | ∘ |
| | | by weight | | | discoloration | | | | | | | | |
| | 4 | BT-120 0.3 parts | 50 | 123 | No | ∘ | 92.2 | 0.3 | 13 | A | A | A | ∘ |
| | | by weight | | | discoloration | | | | | | | | |
| | 5 | BT-120 0.3 parts | 100 | 116 | No | ∘ | 92.2 | 0.4 | 18 | A | A | A | ∘ |
| | | by weight | | | discoloration | | | | | | | | |
| | 6 | BT-120 0.3 parts | 150 | 112 | No | ∘ | 92.2 | 0.4 | 20 | A | A | A | ∘ |
| | | by weight | | | discoloration | | | | | | | | |
| | 7 | BT-120 0.3 parts | 250 | 111 | No | ∘ | 92.2 | 0.5 | 22 | A | A | A | ∘ |
| | | by weight | | | discoloration | | | | | | | | |
| | 8 | BT-120 0.5 parts | 100 | 115 | No | ∘ | 92.2 | 0.6 | 20 | A | A | A | ∘ |
| | | by weight | | | discoloration | | | | | | | | |
| | 9 | BT-120 2 parts | 100 | 122 | No | ∘ | 92.2 | 0.7 | 18 | A | B | A | ∘ |
| | | by weight | | | discoloration | | | | | | | | |
| | 10 | 5M-BTA 0.5 | 100 | 117 | No | ∘ | 92.2 | 0.8 | 18 | A | A | A | ∘ |
| | | parts by weight | | | discoloration | | | | | | | | |
| | 11 | BT-LX 0.5 parts | 100 | 137 | No | ∘ | 92.2 | 0.7 | 18 | A | A | A | ∘ |
| | | by weight | | | discoloration | | | | | | | | |
| | 12 | TT-LX 0.5 parts | 100 | 129 | No | ∘ | 92.2 | 0.7 | 18 | A | A | A | ∘ |
| | | by weight | | | discoloration | | | | | | | | |
| | 13 | NVP 10 parts | 100 | 122 | No | ∘ | 92.3 | 0.3 | 9 | A | B | B | ∘ |
| | | by weight | | | discoloration | | | | | | | | |
| | | 4HBA 8 parts | | | | | | | | | | | |
| | | by weight | | | | | | | | | | | |
| | 14 | NVP 14 parts | 100 | 135 | No | ∘ | 92.3 | 0.6 | 15 | A | B | A | ∘ |
| | | by weight | | | discoloration | | | | | | | | |
| | | 4HBA 25 parts | | | | | | | | | | | |
| | | by weight | | | | | | | | | | | |
| | 15 | BT-120 5 parts | 100 | 131 | No | ∘ | 92.2 | 1.1 | 18 | A | C | A | ∘ |
| | | by weight | | | discoloration | | | | | | | | |
| | 16 | HEA 4 parts | 100 | 127 | No | ∘ | 92.2 | 0.5 | 15 | C | C | A | ∘ |
| | | by weight | | | discoloration | | | | | | | | |
| | 17 | 2EHA/IBXA/ | 100 | 115 | No | ∘ | 92.3 | 0.4 | 5 | C | C | A | ∘ |
| | | NVP = 85/5/5 | | | discoloration | | | | | | | | |
| Com- | 1 | No BTA | 100 | 281 | Discoloration | × | 92.2 | 0.5 | 17 | A | A | A | ∘ |
| par- | 2 | Irganox1010 0.5 | 100 | 343 | Discoloration | × | 92.2 | 0.8 | 19 | A | A | A | ∘ |
| ative | | parts by weight | | | | | | | | | | | |
| Ex- | 3 | Acid present, | 100 | 414 | Discoloration | × | 92.3 | 0.4 | 17 | B | D | B | ∘ |
| am- | | No BTA | | | | | | | | | | | |
| ple | 4 | Acid present, | 100 | 274 | Discoloration | × | 92.3 | 0.5 | 19 | B | D | B | ∘ |
| | | BTA present | | | | | | | | | | | |
| | 5 | Solvent type | 100 | 125 | No | ∘ | 92.1 | 0.5 | 21 | A | B | A | × |
| | | | | | discoloration | | | | | | | | (or- |
| | | | | | | | | | | | | | ange |
| | | | | | | | | | | | | | peel) |
| | 6 | 2EHA = 100 | 100 | — | — | — | — | — | — | — | — | — | — |

### INDUSTRIAL APPLICABILITY

The pressure-sensitive adhesive composition according to the present invention can form a pressure-sensitive adhesive layer that is capable of exhibiting adhesion reliability, transparency, corrosion inhibition effect, and excellent appearance, and enables the number of production steps to be reduced because a protective layer does not need to be coated. Consequently, costs are decreased and yield is improved. Therefore, the pressure-sensitive adhesive composition according to the present invention is useful in display devices including a liquid crystal display (LCD), and input devices including a touch panel, and especially useful in a touch panel application.

### REFERENCE SIGNS LIST

1, 4, 5 Optical Component
2 Touch Panel
3 Metal Wiring
10, 10a, 10b, 10c Pressure-Sensitive Adhesive Sheet
11 Transparent Conductive Film
12a, 12b Transparent Substrate
13 Film Sensor
14a, 14b Polarizing Plate
15 Hard Coat Film
20 Glass With a Step (Step Test Piece)
21 Glass Plate
22 Step
71a, 72a, 73a, 74a, 75a, 76a Metal Wiring (Pattern Wiring)
71b, 72b, 73b, 74b, 75b, 76b Metal Wiring (Pattern Wiring)
81, 82, 83, 84, 85, 86 Electrode (Transparent Electrode)

1. A pressure-sensitive adhesive composition comprising:
a rust inhibitor, and
a mixture of at least one monomer component for constituting a base polymer, or a partially polymerized product of a mixture of at least one monomer component for constituting a base polymer,
the monomer component including no or substantially no acid group-containing monomer,
the pressure-sensitive adhesive composition containing no or substantially no organic solvent.

2. A pressure-sensitive adhesive composition comprising:
a rust inhibitor, and
a base polymer,
the base polymer comprising no or substantially no acid group-containing monomer as a constituent monomer component,
the pressure-sensitive adhesive composition containing no or substantially no organic solvent.

3. A pressure-sensitive adhesive composition comprising:
a rust inhibitor, and
a mixture of at least one monomer component for constituting an acrylic polymer (A), or a partially polymerized product of a mixture of at least one monomer component for constituting an acrylic polymer (A),
the monomer component including no or substantially no acid group-containing monomer,
the pressure-sensitive adhesive composition containing no or substantially no organic solvent.

4. A pressure-sensitive adhesive composition comprising:
a rust inhibitor, and
an acrylic polymer (A),
the acrylic polymer (A) comprising no or substantially no acid group-containing monomer as a constituent monomer component,
the pressure-sensitive adhesive composition containing no or substantially no organic solvent.

5. The pressure-sensitive adhesive composition according to claim 3, wherein a hydroxyl group-containing monomer is not less than 5 parts by weight based on a total amount (100 parts by weight) of the monomer component for constituting the acrylic polymer (A).

6. The pressure-sensitive adhesive composition according to claim 3, wherein a nitrogen atom-containing monomer is not less than 5 parts by weight based on a total amount (100 parts by weight) of the monomer component for constituting the acrylic polymer (A).

7. The pressure-sensitive adhesive composition according to claim 1, wherein the rust inhibitor is a benzotriazole-based compound.

8. A pressure-sensitive adhesive layer formed from the pressure-sensitive adhesive composition according to claim 1.

9. The pressure-sensitive adhesive layer according to claim 8, having a haze (based on JIS K7136) of 1.0% or less.

10. The pressure-sensitive adhesive layer according to claim 7, having a total light transmittance (based on JIS K7361-1) of 90% or more.

11. A pressure-sensitive adhesive sheet comprising the pressure-sensitive adhesive layer according to claim 8.

12. The pressure-sensitive adhesive sheet according to claim 11, having a 180° peel adhesion strength to a glass plate of 8 N/20 mm or more.

13. The pressure-sensitive adhesive sheet according to claim 11, having a thickness of 12 to 350 μm.

14. An optical component comprising:
a base material comprising metal wiring on at least one side thereof, and
at least one pressure-sensitive adhesive sheet according to claim 11, being attached onto the metal wiring side of the base material.

15. The optical component according to claim 14, wherein the metal wiring is copper wiring.

16. A touch panel comprising:
a base material comprising metal wiring on at least one side thereof, and
at least one pressure-sensitive adhesive sheet according to claim 11, being attached onto the metal wiring side of the base material.

17. The touch panel according to claim 16, wherein the metal wiring is copper wiring.

18. The pressure-sensitive adhesive composition according to claim 4, wherein a hydroxyl group-containing monomer is not less than 5 parts by weight based on a total amount (100 parts by weight) of the monomer component for constituting the acrylic polymer (A).

19. The pressure-sensitive adhesive composition according to claim 4, wherein a nitrogen atom-containing monomer is not less than 5 parts by weight based on a total amount (100 parts by weight) of the monomer component for constituting the acrylic polymer (A).

20. The pressure-sensitive adhesive composition according to claim 2, wherein the rust inhibitor is a benzotriazole-based compound.
